(19) United States
(12) Patent Application Publication
(10) Pub. No.: US 2025/0357043 A1
(43) Pub. Date: Nov. 20, 2025

(54) HOME APPLIANCE INCLUDING INDUCTOR EMPLOYING BIAS MAGNETS

(71) Applicant: SAMSUNG ELECTRONICS CO., LTD., Suwon-si (KR)

(72) Inventors: Hyomin AHN, Suwon-si (KR); Jeongil KANG, Suwon-si (KR); Jehyung CHO, Suwon-si (KR)

(21) Appl. No.: 19/068,429

(22) Filed: Mar. 3, 2025

Related U.S. Application Data
(63) Continuation of application No. PCT/KR2025/000107, filed on Jan. 3, 2025.

(30) Foreign Application Priority Data
May 20, 2024 (KR) 10-2024-0065359

(51) Int. Cl. H01F 37/00; H01F 3/10; H01F 3/14; H01F 5/02; H01F 7/02; H02M 1/42

(52) U.S. Cl. CPC H01F 37/00; H01F 3/14; H01F 5/02; H01F 7/0221; H02M 1/4208; H01F 2003/103

(57) ABSTRACT

A home appliance includes an inductor to which a bias magnet is applied. The inductor of the home appliance may include a core including an air gap in a first leg, and a coil wound around at least a part of the core such that flux flows through the first leg. An upper magnet is positioned above the air gap in the first leg, and a lower magnet is positioned below the air gap in the first leg. In this regard, a direction of flux by the coil may be opposite to a direction of flux by the upper magnet and the lower magnet.

### CROSS-REFERENCE TO RELATED APPLICATION(S)

This application is a continuation application, under 35 U.S.C. § 111(a), of international application No. PCT/KR2025/000107, filed on Jan. 3, 2025, which claims priority under 35 U. S. C. § 119 to Korean Patent Application No. 10-2024-65359, filed on May 20, 2024, in the Korean Intellectual Property Office, the disclosures of which are incorporated herein by reference in their entirety.

### TECHNICAL FIELD

The present disclosure relates to a home appliance including an inductor employing bias magnets.

### BACKGROUND ART

Many home appliances include direct current (DC) inductors in which current flows in only one direction. DC inductors are widely used in power factor correction (PFC) circuits. As cores for the DC inductors, ferrite cores are widely used. Ferrite cores have the advantages of being inexpensive and having low magnetic loss at high frequencies, but have the disadvantage of easily becoming magnetically saturated. When magnetic saturation occurs, inductance is greatly reduced. Therefore, DC inductors containing ferrite cores are difficult to apply in high current applications such as PFC circuits used in home appliances.

### DISCLOSURE

### Technical Solution

According to an embodiment of the disclosure, a home appliance including an inductor equipped with a bias magnet is disclosed. According to an embodiment of the disclosure, the home appliance may include a rectifier circuit configured to rectify an alternating current (AC) voltage of an input power source, a power circuit in signal communication with the rectifier circuit including an inductor that utilizes a magnet, the power circuit configured to perform power conditioning on the rectified DC voltage, and a link capacitor connected to the power circuit and configured to smooth the rectified DC voltage. According to an embodiment of the disclosure, the home appliance may include the power circuit, and the power circuit may include the inductor. According to an embodiment of the disclosure, the power circuit may include a PFC (power factor correction) circuit including the inductor, a switched mode power supply (SMPS) including the inductor, or a power converter including the inductor.

According to an embodiment of the disclosure, a home appliance including an inductor equipped with a bias magnet is disclosed. According to an embodiment of the disclosure, the home appliance may include a rectifier circuit configured to rectify an AC voltage of an input power source, a PFC circuit configured to correct a power factor of a voltage rectified by the rectifier circuit, and a link capacitor connected to the PFC circuit and configured to smooth a DC voltage. According to an embodiment of the disclosure, the home appliance may include the PFC circuit, and the PFC circuit may include the inductor. According to an embodiment of the disclosure, the home appliance may include a switched mode power supply (SMPS) including an inductor, instead of the PFC circuit. According to an embodiment of the disclosure, the home appliance may include a power converter including the inductor, instead of the PFC circuit.

According to an embodiment of the disclosure, the inductor included in the PFC circuit, the SMPS, and/or the power converter may include a core including an air gap in a first leg. According to an embodiment of the disclosure, the inductor may include a coil wound around at least a part of the core such that flux flows through the first leg. According to an embodiment of the disclosure, the inductor may include an upper magnet positioned above the air gap in the first leg. According to an embodiment of the disclosure, the inductor may include a lower magnet positioned below the air gap in the first leg. In the inductor according to an embodiment of the disclosure, a direction of flux by the coil may be opposite to a direction of flux by the upper magnet and the lower magnet. According to a non-limiting embodiment of the disclosure, the inductor may include only any one of the upper magnet or the lower magnet when the upper magnet or the lower magnet includes an electromagnetic coil formed by winding a coil.

### DESCRIPTION OF DRAWINGS

FIG. 1A is a circuit diagram of power converters using an inductor according to an embodiment of the disclosure.

FIG. 1B is a circuit diagram of power converters using an inductor according to an embodiment of the disclosure.

FIG. 1C is a circuit diagram of power converters using an inductor according to an embodiment of the disclosure.

FIG. 2 shows a BH curve representing characteristics of an inductor.

FIG. 3 shows shifting a BH curve to the right according to an embodiment of the disclosure.

FIG. 4 shows shifting a BH curve to the right by applying a bias magnet according to an embodiment of the disclosure.

FIG. 5 shows a biased core having a bias magnet positioned in an air gap, according to an embodiment of the disclosure.

FIG. 6 shows fringing flux generated in a square core.

FIG. 7 shows a core structure to which bias magnets are attached, according to an embodiment of the disclosure.

FIG. 8A shows a core structure to which bias magnets are attached, according to an embodiment of the disclosure.

FIG. 8B shows a core structure to which bias magnets are attached, according to an embodiment of the disclosure.

FIG. 8C shows a core structure to which bias magnets are attached, according to an embodiment of the disclosure.

FIG. 8D shows a core structure to which bias magnets are attached, according to an embodiment of the disclosure.

FIG. 9A shows a core structure having bias magnets formed on side legs, according to an embodiment of the disclosure.

FIG. 9B shows a core structure having bias magnets formed on side legs, according to an embodiment of the disclosure.

FIG. 9C shows a core structure having bias magnets formed on side legs, according to an embodiment of the disclosure.

FIG. 9D shows a core structure having bias magnets formed on side legs, according to an embodiment of the disclosure.

FIG. 10A shows a structure in which bias magnets are attached to a rectangular core, according to an embodiment of the disclosure.

FIG. 10B shows a structure in which bias magnets are attached to a rectangular core, according to an embodiment of the disclosure.

FIG. 10C shows a structure in which bias magnets are attached to a rectangular core, according to an embodiment of the disclosure.

FIG. 10D shows a structure in which bias magnets are attached to a rectangular core, according to an embodiment of the disclosure.

FIG. 11A shows a core structure to which bias magnets by coils are attached, according to an embodiment of the disclosure.

FIG. 11B shows a core structure to which bias magnets by coils are attached, according to an embodiment of the disclosure.

FIG. 11C shows a core structure to which bias magnets by coils are attached, according to an embodiment of the disclosure.

FIG. 12A shows a core structure to which bias magnets by coils are attached, according to an embodiment of the disclosure.

FIG. 12B shows a core structure to which a bias magnet by a coil is attached, according to an embodiment of the disclosure.

FIG. 13A shows a core structure to which a bias magnet by a coil is attached, according to an embodiment of the disclosure.

FIG. 13B shows a core structure to which a bias magnet by a coil is attached, according to an embodiment of the disclosure.

FIG. 14A shows a core structure to which a bias magnet is attached, according to an embodiment of the disclosure.

FIG. 14B shows a core structure to which bias magnets are attached, according to an embodiment of the disclosure.

FIG. 15A is cross-sectional views of bias magnets according to an embodiment of the disclosure.

FIG. 15B is cross-sectional views of bias magnets according to an embodiment of the disclosure.

FIG. 15C is cross-sectional views of bias magnets according to an embodiment of the disclosure.

FIG. 15D is cross-sectional views of bias magnets according to an embodiment of the disclosure.

FIG. 15E is cross-sectional views of bias magnets according to an embodiment of the disclosure.

FIG. 15F is perspective views of bias magnets according to an embodiment of the disclosure.

FIG. 16 shows bobbin structures according to an embodiment of the disclosure.

FIG. 17A is a diagram showing flux changes according to changes of coil current in a case in which bias magnets are installed on a core center leg, according to an embodiment of the disclosure.

FIG. 17B is a diagram showing flux changes according to changes of coil current in a case in which bias magnets are installed on a core center leg, according to an embodiment of the disclosure.

FIG. 17C is a diagram showing flux changes according to changes of coil current in a case in which bias magnets are installed on a core center leg, according to an embodiment of the disclosure.

FIG. 17D is a diagram showing flux changes according to changes of coil current in a case in which bias magnets are installed on a core center leg, according to an embodiment of the disclosure.

FIG. 17E is a diagram showing flux changes according to changes of coil current in a case in which a bias magnet is installed on a cross-section of a core center leg, according to an embodiment of the disclosure.

FIG. 17F is a diagram showing flux changes according to changes of coil current in a case in which a bias magnet is installed on a cross-section of a core center leg, according to an embodiment of the disclosure.

FIG. 17G is a diagram showing flux changes according to changes of coil current in a case in which a bias magnet is installed on a cross-section of a core center leg, according to an embodiment of the disclosure.

FIG. 17H is a diagram showing flux changes according to changes of coil current in a case in which a bias magnet is installed on a cross-section of a core center leg, according to an embodiment of the disclosure.

FIG. 18 is a graph showing a relationship between inductance and current in the case in which a bias magnet according to an embodiment of the disclosure is applied to a core.

FIG. 19 is a block diagram of a home appliance according to an embodiment of the disclosure.

FIG. 20 shows an air conditioner using an inductor according to an embodiment of the disclosure.

FIG. 21 shows a refrigerator using an inductor according to an embodiment of the disclosure.

FIG. 22 shows a washing machine using an inductor according to an embodiment of the disclosure.

FIG. 23 shows an induction heating device using an inductor according to an embodiment of the disclosure.

### MODE FOR INVENTION

Terms used in the disclosure will be briefly described, and an embodiment of the disclosure will be described in detail.

Although general terms being currently widely used were selected as terminology used in the disclosure while considering the functions in the disclosure, they may vary according to intentions of one of ordinary skill in the art, judicial precedents, the advent of new technologies, and the like Also, terms arbitrarily selected by the applicant may also be used in a specific case. In this case, their meanings will be described in detail in the corresponding embodiments of the disclosure. Hence, the terms used in the disclosure must be defined based on the meanings of the terms and the entire content of the disclosure, not by simply stating the terms themselves.

In the disclosure, the expression “at least one of a, b or c” indicates “a”, “b”, “c”, “a and b”, “a and c”, “b and c”, “all of a, b, and c”, or variations thereof.

Throughout the disclosure, it will be understood that when a certain part “includes” a certain component, the part does not exclude another component but can further include another component, unless the context clearly dictates otherwise. As used herein, the terms “part”, “portion”, “module”, or the like refers to a unit that can perform at least one function or operation, and may be implemented as hardware, software, or a combination of hardware and software.

Hereinafter, the embodiments of the disclosure will be described in detail with reference to the accompanying drawings such that one of ordinary skill in the technical field to which the disclosure belongs may easily embody the disclosure. However, an embodiment of the disclosure can be implemented in various different forms, and is not limited to the embodiments described herein. Also, in the drawings, portions irrelevant to the description are not shown in order to definitely describe an embodiment of the disclosure, and throughout the disclosure, similar components are assigned similar reference numerals.

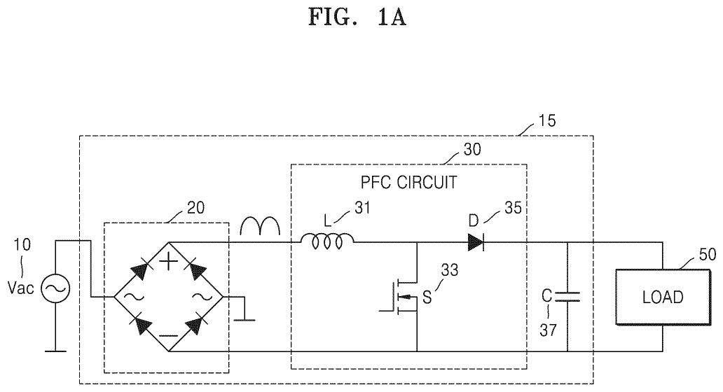

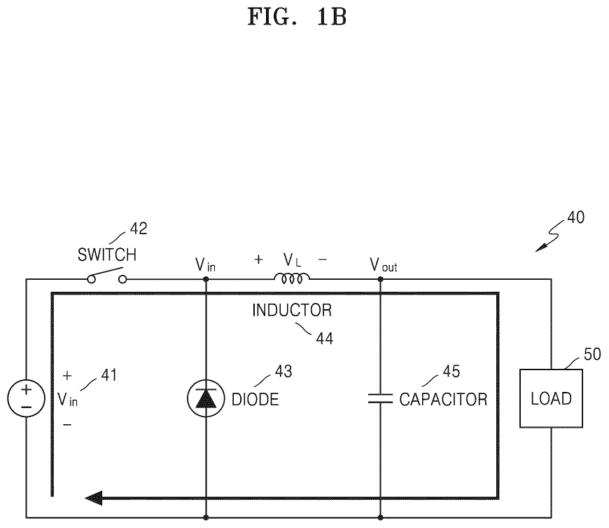

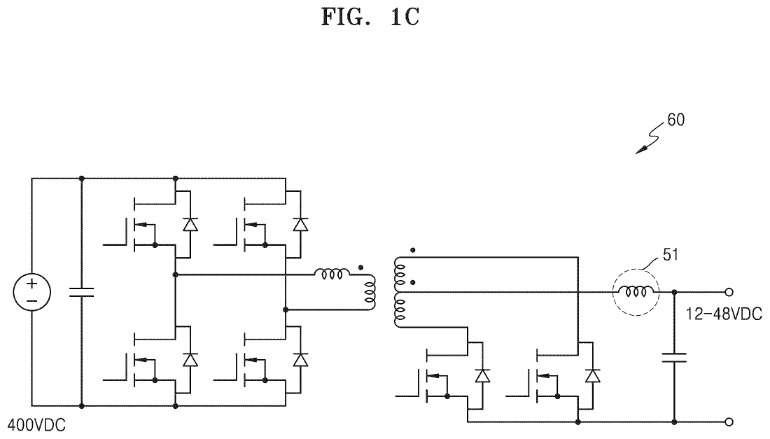

FIG. 1A is a circuit diagram depicting a power converter using an inductor according to an embodiment of the disclosure.

FIG. 1A shows a circuit diagram of a power converter including a power factor correction (PFC) circuit. The power converter may be included in various home appliances according to an embodiment of the disclosure.

A power converter 15 may include a rectifier 20, a PFC circuit 30, and a capacitor 37. The capacitor 37 may be a direct current (DC) link capacitor or a link capacitor. An input power source 10 may be an alternating current (AC) voltage, and the AC voltage may be rectified into a DC voltage through the rectifier 20 including a rectifier circuit. The rectified DC voltage may be established and smoothed as a DC voltage by the capacitor 37 via the PFC circuit 30. The rectifier circuit may include, but is not limited thereto, a bridge diode, and a gate-controlled switching device may replace the bridge diode. The power converter 100 may be connected to a load 50 and supply power required by the load 50 to the load 50. The PFC circuit 30 may include an inductor 31, a switch 33, and a diode 35. Increasing inductance of the inductor 31 in the PFC circuit 30 may reduce surge current in a non-switched section of the switch 33, but increase a volume of a system. In contrast, decreasing inductance of the inductor 31 in the PFC circuit 30 may increase surge current in the non-switched section of the switch 33. The switch 33 of the PFC circuit 30 may include an active switch device. The switch 33 may be configured with an Insulated Gate Bipolar Transistor (IGBT), a transistor, or a Metal Oxide Semiconductor Field Effect Transistor (MOSFET), but the disclosure is not limited thereto.

The inductor 31 of the PFC circuit 30 may include a DC inductor in which current flows in only one direction. According to an embodiment of the disclosure, the inductor 31 may be a DC inductor and may include an inductor including a bias magnet to expand a magnetic saturation region.

FIG. 1B is a circuit diagram of power converters using an inductor according to an embodiment of the disclosure.

Referring to FIG. 1B, a circuit diagram of a power converter using an inductor according to an embodiment of the disclosure is disclosed. In FIG. 1B, a buck converter 40 is shown as the power converter. The power converter may be included in various home appliances according to an embodiment of the disclosure.

In the disclosure, for example, a voltage (41 in FIG. 1B) across an equivalent voltage source corresponding to a DC link capacitor may be reduced and used for a load 50. According to an embodiment of the disclosure, a voltage across the DC link capacitor may be 311 V and the load 50 may be a type of energy storage device that is charged to 30 V. In this case, the power converter of FIG. 1B may be a buck converter 40.

The buck converter 40 may convert (step-down convert) a high-voltage input voltage (Vᵢₙ) 41 to provide a low voltage to the load 50. For step-down conversion, a switch 42, a diode 43, an inductor 44, and a capacitor 45 may be used. A configuration of the buck converter 40 shown in FIG. 1B may depend on a designer's selection. Because a direction of current passing through the inductor 44 does not change, the inductor 44 may be a DC inductor using a bias magnet, according to an embodiment of the disclosure. In the disclosure, the bias magnet may include a magnet that enables an inductor to act as a biased inductor. In the disclosure, the bias magnet may include a permanent magnet and/or an electromagnet by a coil. The DC inductor may include an inductor in which current flows in one direction.

FIG. 1C is a circuit diagram of power converters using an inductor according to an embodiment of the disclosure.

In FIG. 1C, a circuit diagram of a power converter using an inductor according to an embodiment of the disclosure is shown. The power converter may be included in various home appliances according to an embodiment of the disclosure.

A power converter 60 shown in FIG. 1C may be a phase shift full bridge converter and may be used for a load with a high step-down ratio. The power converter 60 of FIG. 1C may have a high-voltage input of, for example, 400 V, and may reduce the high-voltage input to a low voltage of about 12 V to about 48 V. The power converter 60 may include an inductor 51 including a bias magnet according to an embodiment of the disclosure.

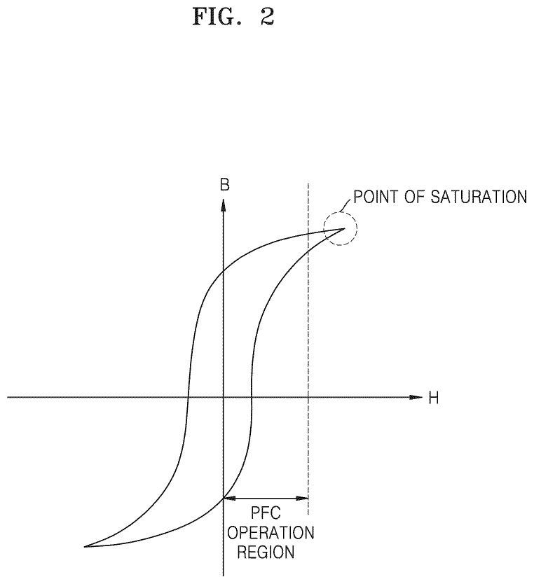

FIG. 2 shows a BH curve representing characteristics of an inductor.

Characteristics of an inductor may be described by the BH curve shown in FIG. 2. As seen in the BH curve of FIG. 2, magnetization of a magnetic material has nonlinear and hysteresis characteristics.

In the BH curve, H represents strength of a magnetic field. H is a value obtained by dividing a product of the number of turns of a coil and current flowing through the coil by a magnetic path length l. In an inductor having a specific number of turns of a coil and a specific magnetic path length, H is proportional to a magnitude of current flowing through the coil. Therefore, current flowing through a coil wound around a core may increase toward the right in FIG. 2.

B is flux density generated in a magnetic circuit by the inductor. In the BH curve, a slope represents magnetic permeability of the inductor. The magnetic permeability of the inductor is proportional to inductance of the inductor. As the slope of the BH curve flattens, magnetic saturation occurs which reduces the inductance of the inductor. Accordingly, a point where saturation occurs as indicated in FIG. 2 is a point where the slope is small (the slope becomes flat). In a PFC circuit, a direction of current flowing through an inductor is constant. In other words, an inductor used in a PFC circuit is a DC inductor in which a direction of current is constant. Accordingly, a DC inductor needs to be designed such that an operation region (0 current to maximum current) of a PFC (circuit) does not reach the saturation point indicated in FIG. 2. The PFC may include at least one of a boost PFC, a passive PFC, or a buck PFC. Also, although the BH curve in FIG. 2 shows an operation region of a PFC, the disclosure is not limited thereto. For example, because a DC inductor is also used in a switched mode power supply (SMPS), the operation region of the PFC in FIG. 2 may be replaced with an operation region of an SMPS. Also, in the case in which a power conversion circuit uses a DC inductor, the PFC of FIG. 2 may be replaced with such a power conversion circuit.

As seen from FIG. 2, because the PFC has a constant current direction, the inductor may operate only in first and fourth quadrants of the BH curve. Shifting the BH curve to the right will prevent saturation at the point where saturation occurs in FIG. 2.

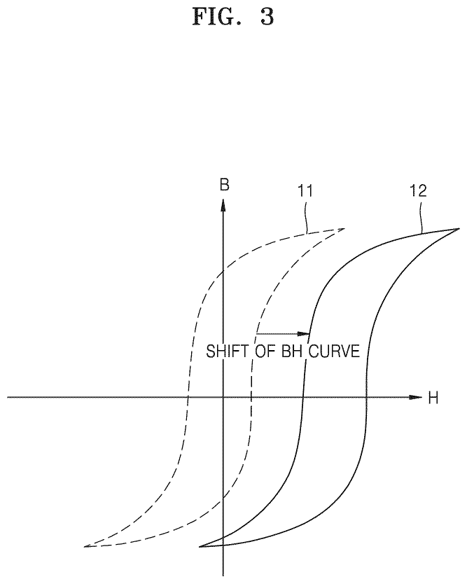

FIG. 3 shows shifting a BH curve to the right according to an embodiment of the disclosure.

In FIG. 3, an initial BH curve is a first BH curve 11, and a BH curve obtained by shifting the initial BH curve is a second BH curve. As seen in FIG. 3, when the first BH curve 11 is shifted to the second BH curve 12, a region where saturation occurs in the first BH curve 11 will become a region where saturation no longer occurs in the second BH curve 12. Therefore, when the first BH curve 11 is shifted to the second BH curve 12, usability of the DC inductor will increase.

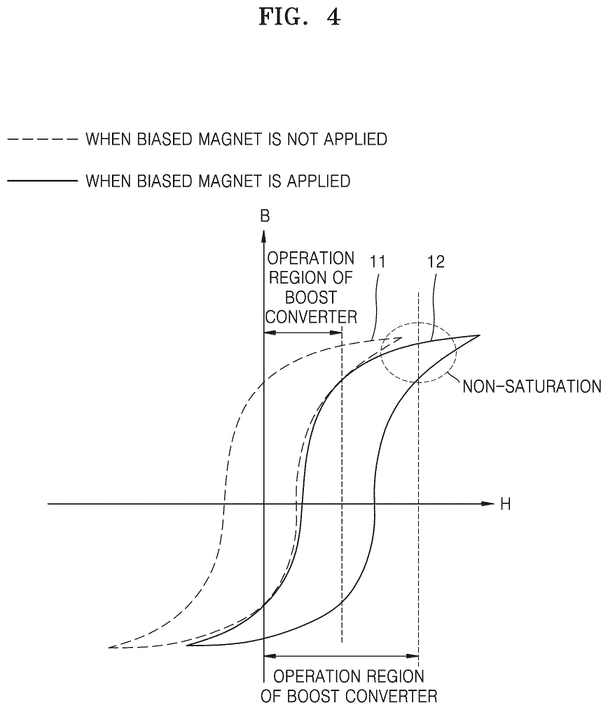

FIG. 4 shows shifting a BH curve to the right by applying a bias magnet according to an embodiment of the disclosure.

Referring to FIG. 4, the first BH curve 11 may be shifted to the second BH curve 12 by a bias magnet. Therefore, a saturation region in the first BH curve 11 may be no longer a saturation region in the second BH curve 12. Also, a boost converter operation region in the second BH curve 12 may be much wider than that in the first BH curve 11. Additionally, flux loss may also be further reduced in the second BH curve 12.

A core of an inductor that generates the second BH curve 12 in FIG. 4 is called a biased core. When a biased core is used as a DC inductor, a core size may be reduced and hysteresis loss may be reduced.

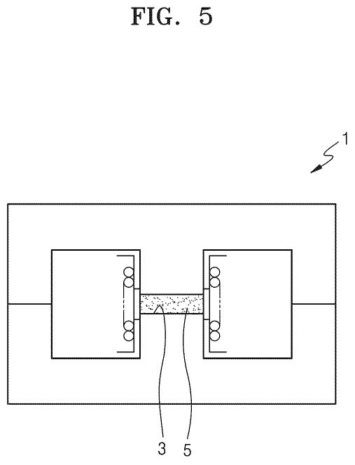

FIG. 5 shows a biased core having a bias magnet positioned in an air gap, according to an embodiment of the disclosure.

FIG. 5 is an example of a biased core 1 showing a bias magnet 5 inserted into an air gap 3. The biased core 1 shown in FIG. 5 may be an EE type core, and may include an air gap in a center leg. The bias magnet 5 may be a permanent magnet. However, when the biased core 1 shown in FIG. 5 is used, flux generated by a coil wound around the biased core 1 may be applied to the bias magnet 5 in a direction that is opposite to a direction of flux of the bias magnet 5. When overcurrent is applied to the coil due to a failure or instantaneous overload in such a structure as shown in FIG. 5, large flux may be applied to the bias magnet 5 due to the overcurrent, which may cause irreversible demagnetization in the bias magnet 5. Due to the irreversible demagnetization caused in the bias magnet 5, the bias magnet 5 may eventually lose magnetism. When the bias magnet 5 loses magnetism, the inductor may operate as a normal inductor. Therefore, a biased core design for preventing demagnetization of the bias magnet 5 may be required.

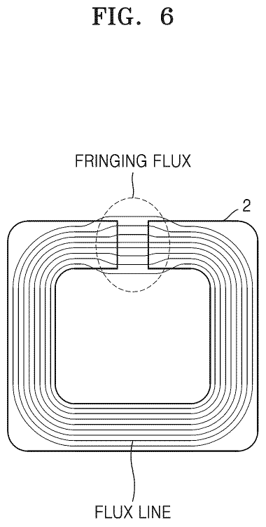

FIG. 6 shows fringing flux generated in a square core.

While a biased core is manufactured, a bias magnet may be attached to an outer side of the biased core. To prevent irreversible demagnetization of a bias magnet, the bias magnet may be attached to an outer side of a core, and in this case, an air gap may also be located in the outer side of the biased core to set a flux path of the bias magnet. However, in this case, electromagnetic interference (EMI) may occur due to radiated noise caused by fringing flux occurred around the air gap. Accordingly, locating an air gap in an outer leg of a core may be vulnerable to radiated noise.

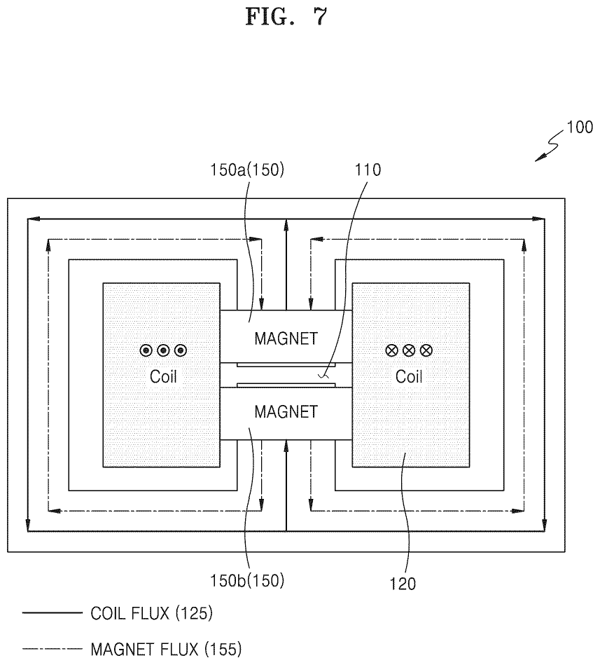

FIG. 7 shows a core structure to which bias magnets are attached, according to an embodiment of the disclosure.

Referring to FIG. 7, a pair of bias magnets 150 (e.g., 150a and 150b) included in a core 100 may be respectively positioned above and below an air gap 110. For convenience of description, the bias magnet 150 positioned above the air gap 110 is referred to as an upper magnet 150a, and the bias magnet 150 positioned below the air gap 110 is referred to as a lower magnet 150b.

The core 100 shown in FIG. 7 may be a path through which flux generated by a coil 120 and the bias magnets 150 mainly flows. The core 100 may include, but is not limited thereto, a ferrite core. The core 100 may be a PQ, EE, or EI type. Accordingly, the core 100 may be a type having three legs and an air gap formed in a center leg (middle leg). To distinguish the center leg from the three legs, the center leg is referred to as a first leg. However, throughout the disclosure, a first leg is used relatively according to an embodiment of the disclosure, and a leg of a core where a bias magnet is positioned is referred to as a first leg.

The air gap 110 may be an empty space located on the path through which flux flows and may limit a magnitude of flux in a magnetic circuit. The air gap 110 may perform a similar function to a resistor that limits current in an electric circuit. The air gap 110 may function to prevent saturation of the core 100 by limiting a magnitude of flux. The air gap 110 according to an embodiment of the disclosure may be located in the center leg of the core 100.

The coil 120 may be made of a conductor for generating flux. While current flows through the coil 120, coil flux 125 may be generated by the coil 120. In other words, electrical energy may be converted into magnetic energy by the coil 120. A flux direction of the coil flux 125 may depend on a direction of current flowing through the coil 120 and a direction in which the coil 120 is wound. When the coil flux 125 exceeds a flux rate value of the core 100, saturation of the inductor may occur. When saturation of the inductor occurs, the inductor may no longer operate as an inductor. Accordingly, the core 100 may need to be designed such that the coil flux 125 is within the flux rate value of the core 100.

The bias magnets 150 may also generate flux. The flux is referred to as magnet flux 155. The magnet flux 155 by the bias magnets 150 may exit a N pole and enter a S pole. Due to flux resistance by the air gap 110, it may be desirable to form flux that exits from a N pole of the upper magnet 150a and enters a S pole of the lower magnet 150b. Therefore, according to an embodiment of the disclosure, the bias magnets 150 may be designed such that an upper portion of the upper magnet 150a becomes a N pole and a lower portion of the upper magnet 150a becomes a S pole while an upper portion of the lower magnet 150b becomes a N pole and a lower portion of the lower magnet 150b becomes a S pole. However, this may be only an example embodiment, and magnetic poles of the upper magnet 150a and the lower magnet 150b may be arranged horizontally with respect to the air gap 110. According to an embodiment of the disclosure, in the case in which the magnetic poles are arranged horizontally, an inner side of the upper magnet 150a with respect to the center leg may become a N pole and an outer side of the upper magnet 150a may become a S pole, while an inner side of the lower magnet 150b with respect to the center leg may become a S pole and an outer side of the lower magnet 150b may become a N pole. According to an embodiment of the disclosure, the magnetic poles of the bias magnets 150 may be arranged such that the direction of the coil flux 125 by the coil 120 is opposite to a direction of the magnet flux 155. Arrangements of the bias magnets 150 will be described in more detail, below

Also, the core 100 may be designed such that the direction of magnet flux 155 by the bias magnets 150 is opposite to a direction of coil flux 125 by the coil 120 to reduce a total magnitude (coil flux 125-magnet flux 155) of flux.

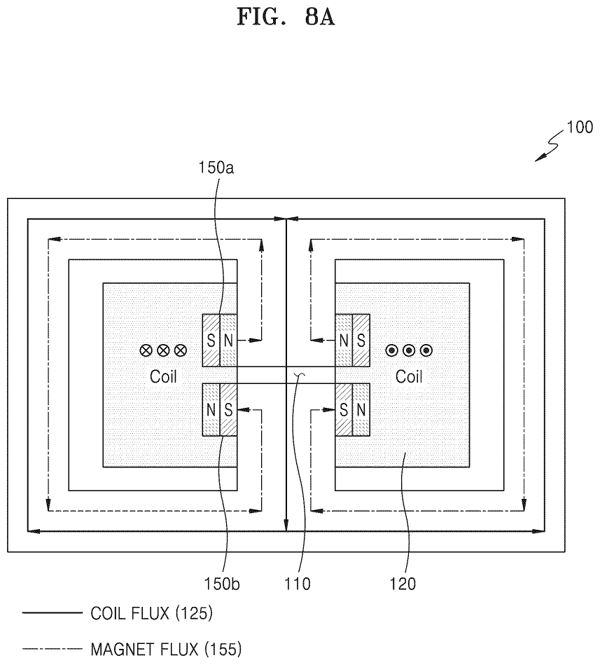

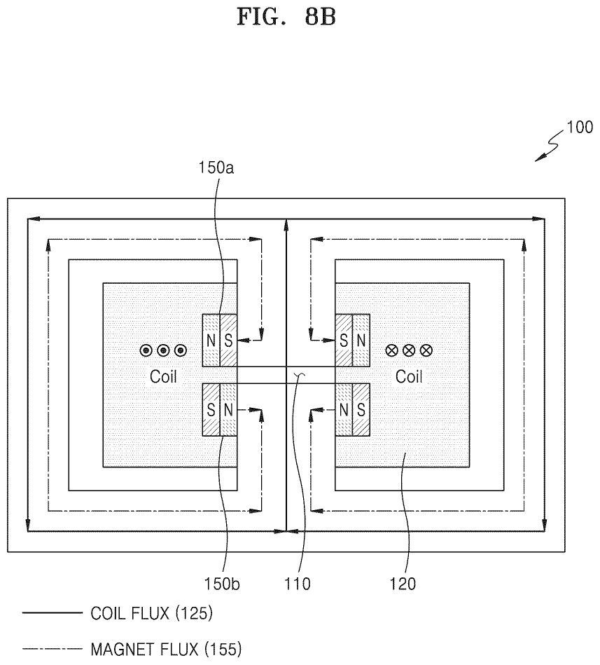

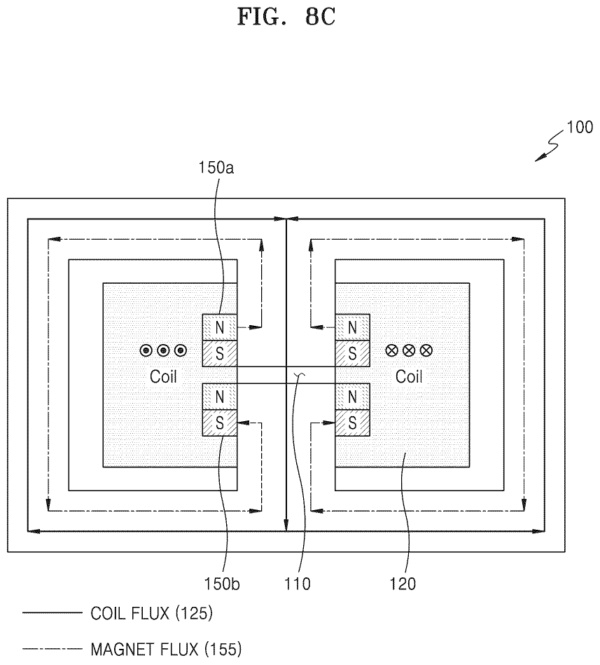

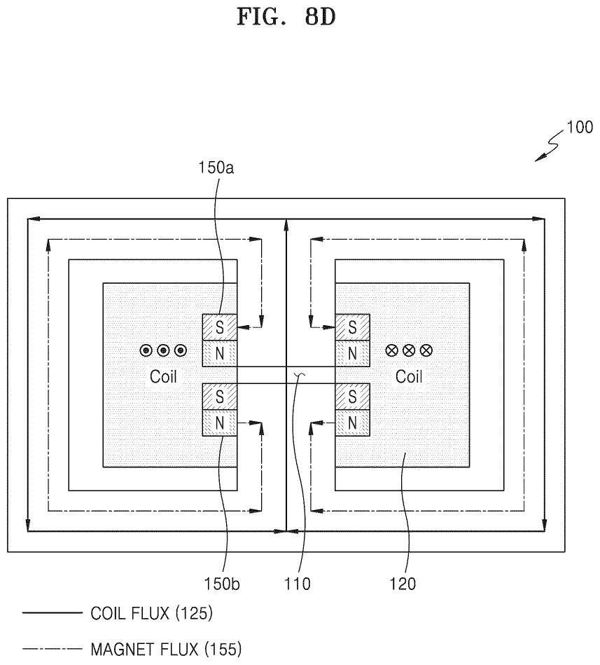

FIG. 8A shows a core structure to which bias magnets are attached, according to an embodiment of the disclosure.

A core 100 of FIG. 8A shows how magnetic poles of bias magnets 150 are arranged in the core structure of FIG. 7. According to an embodiment of the disclosure, the magnetic poles may be arranged such that a direction of magnet flux 155 by the bias magnets 150 is opposite to a direction of coil flux 125. As shown in FIG. 8A, when an upper magnet 150a is positioned such that the inner side becomes a N pole and the outer side becomes a S pole while a lower magnet 150b is positioned such that the inner side becomes a S pole and the outer side becomes a N pole, a direction of magnet flux 155 may be opposite to a direction of coil flux 125. The magnet flux 155 exits from the N pole of the upper magnet 150a may flow upward along a center leg of the core 100 without flowing downward, due to flux resistance of an air gap 110. The magnet flux 155 flowed upward along the center leg of the core 100 may enter the S pole positioned at the inner side of the lower magnet 150b.

FIG. 8B shows a core structure to which bias magnets are attached, according to an embodiment of the disclosure.

A core 100 of FIG. 8B shows how magnetic poles of bias magnets 150 are arranged in the core structure of FIG. 7. Also, in the core 100 of FIG. 8B, a coil 120 may be wound in an opposite direction of a winding direction of the coil 120 in FIG. 8A, and therefore, a direction of coil flux 125 may be opposite to the direction of the coil flux 125 of FIG. 8A. Accordingly, the magnetic poles of the bias magnets 150 may be arranged such that a direction of magnet flux 155 is opposite to a direction of the coil flux 125. According to an embodiment of the disclosure, the bias magnets 150 of FIG. 8B may be arranged such that an inner side of an upper magnet 150a becomes a S pole and an outer side of the upper magnet 150a becomes a N pole while an inner side of a lower magnet 150b becomes a N pole and an outer side of the lower magnet 150b becomes a S pole. By this arrangement of the magnetic poles, a direction of magnet flux 155 may become opposite to a direction of coil flux 125.

As described above, magnet flux 155 exits from the N pole of the lower magnet 150b may flow downward along a center leg of the core 100 without flowing upward, due to an air gap 110. The magnet flux 155 flowed downward along the center leg of the core 100 may enter the S pole positioned at the inner side of the upper magnet 150a.

FIG. 8C shows a core structure to which bias magnets are attached, according to an embodiment of the disclosure.

Compared to the structures of the cores 100 of FIGS. 8A and 8B in which the magnetic poles of the bias magnets 150 are arranged horizontally, magnetic poles of bias magnets 150 of FIG. 8C may be arranged vertically. When the magnetic poles of the bias magnets 150 are arranged vertically such that a direction of magnet flux 155 is opposite to a direction of coil flux 125, a core 100 may have a biased core structure. However, when the magnetic poles of the bias magnets 150 are arranged vertically as in FIG. 8C, strength of the magnetic poles may need to be a little greater than in the structures of the cores 100 of FIGS. 8A and 8B in which the magnetic poles of the bias magnets 150 are arranged horizontally, to obtain a similar effect to the structures of the cores 100 including the bias magnets 150 of FIGS. 8A and 8B.

Referring to FIG. 8C, upper portions of an upper magnet 150a and a lower magnet 150b may become N poles, and lower portions of the upper magnet 150a and the lower magnet 150b may become S poles. Magnet flux 155 exits from the N pole of the upper pole 150a may flow upward along a center leg of the core 100 without flowing downward along the center leg, due to an air gap 110. The magnet flux 155 exits from the N pole of the upper pole 150a may flow along the core 100 and enter the S pole of the lower magnet 150b. However, this is only an example embodiment, and when a winding direction of the coil 120 is reversed, the arrangement of the bias magnets 150 may also change. The related example is shown in FIG. 8D.

FIG. 8D shows a core structure to which bias magnets are attached, according to an embodiment of the disclosure.

In FIG. 8D, magnetic poles of bias magnets 150 may also be arranged vertically, as in FIG. 8C. However, a direction of coil flux 125 in FIG. 8D may be opposite to that in FIG. 8C.

Referring to FIG. 8D, an upper portion of a lower magnet 150b may become a S pole, and a lower portion of the lower magnet 150b may become a N pole. Magnet flux 155 exits from the N pole of the lower magnet 150b may flow downward along a center leg of a core 100 without flowing upward along the center leg, due to an air gap 110. Also, an upper portion of an upper magnet 150a may become a S pole, and a lower portion of the upper magnet 150a may become a N pole. The magnet flux 155 exits from the N pole of the lower magnet 150b may flow along the core 100 and enter the S pole of the upper magnet 150a.

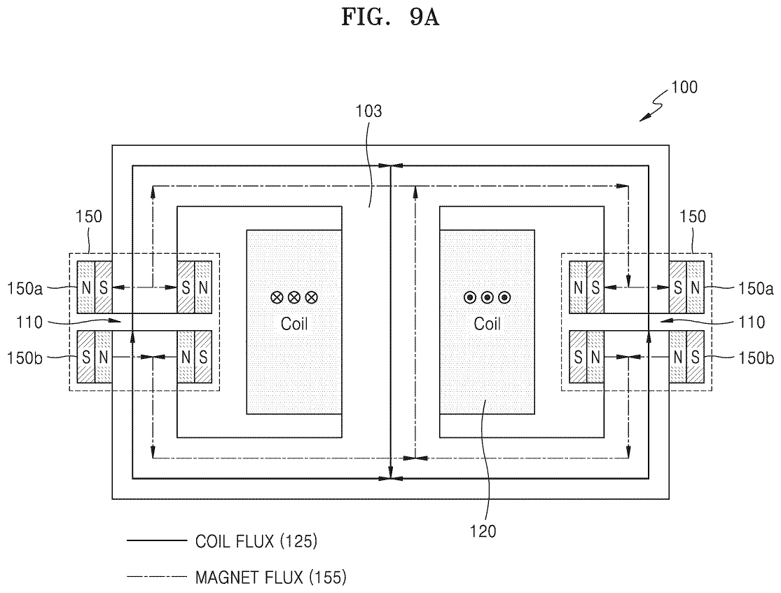

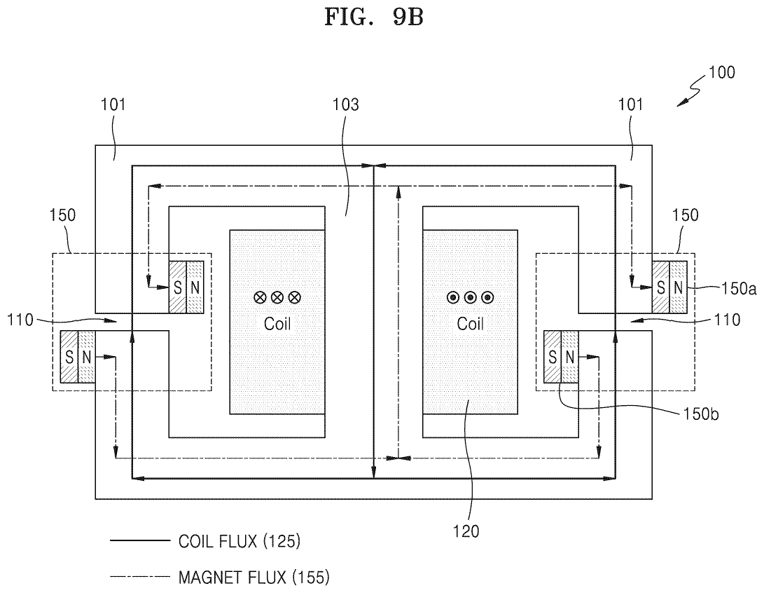

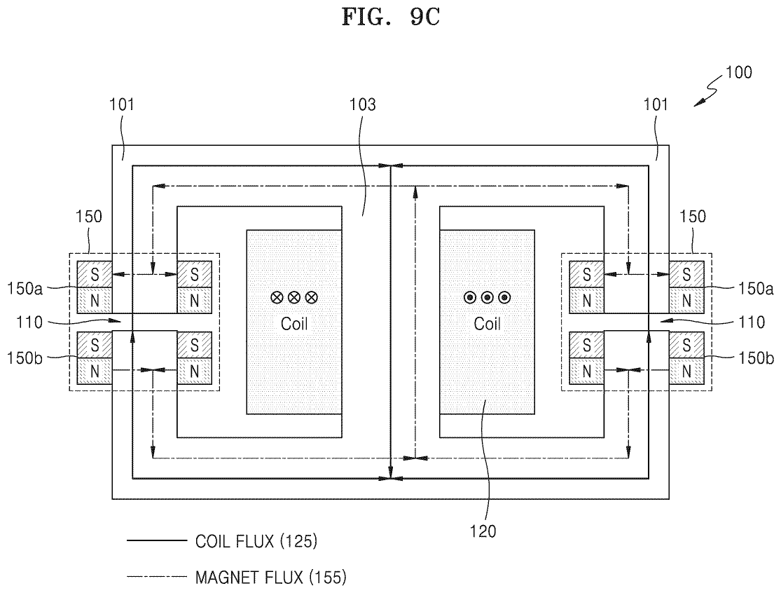

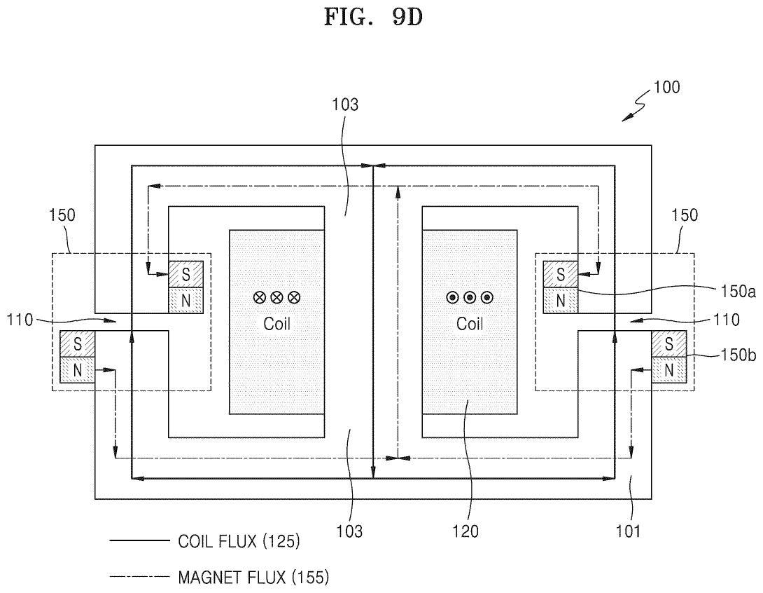

FIG. 9A shows a core structure having bias magnets formed on a side leg according to an embodiment of the disclosure.

While the core structures of FIGS. 8A to 8D have the air gaps 110 in the center legs, a core 100 of FIG. 9A may have an air gap 110 located in both side legs. In cores 100 of FIGS. 9A to 9D, first legs 101 may be both side legs and center legs 103 may have no air gap. The core 100 may include a PQ, EE, or EI type.

According to an embodiment of the disclosure, bias magnets 150 may be positioned on both side legs which are the first legs 101 with air gaps 110. The bias magnets 150 may be located above and below the air gaps 110 positioned in the both side legs. Magnetic poles of the bias magnets 150 may be arranged such that a direction of magnet flux 155 by the bias magnets 150 is opposite to a direction of coil flux 125.

Referring to FIG. 9A, when a S pole is positioned at an inner side of an upper magnet 150a and a N pole is positioned at an outer side of the upper magnet 150a while an inner side of a lower magnet 150b becomes a N pole and an outer side of the lower magnet 150b becomes a S pole, a direction of magnet flux 155 may become opposite to a direction of coil flux 125. Magnet flux 155 exits from the N pole of the lower magnet 150b may flow downward along one side leg of the core 100 without flowing upward, due to one air gap 110. The magnet flux 155 flowed downward along the side leg of the core 100 may pass through a center leg and then enter the S pole positioned at the inner side of the upper magnet 150a.

However, this is only an example embodiment, and when a coil 120 is wound in an opposite direction in FIG. 9A, the arrangement of the magnetic poles of the upper magnet 150a and the lower magnet 150b may be reversed. Accordingly, when the winding direction of the coil 120 is reversed in FIG. 9A, a direction of coil flux 125 will also be reversed, and accordingly, a direction of magnet flux 155 may also need to be reversed. To this end, the magnetic poles may be positioned such that the inner side of the upper magnet 150a becomes a N pole and the outer side of the upper magnet 150a becomes a S pole while the inner side of the lower magnet 150b becomes a S pole and the outer side of the lower magnet 150b becomes a N pole.

FIG. 9B shows a core structure having bias magnets formed on side legs, according to an embodiment of the disclosure.

A core 100 of FIG. 9B may also include air gaps 110 in both side legs, like the core 100 of FIG. 9A.

FIG. 9B shows an example embodiment in which bias magnets 150 surround only a portion of the side legs, instead of the entire side legs, unlike the bias magnets 150 of FIG. 9A. In the example shown in FIG. 9B, an upper magnet 150a and a lower magnet 150b may surround only at least a portion of each side leg 101, instead of the entire side leg 101. According to a non-limiting embodiment of the disclosure, in the core 100 of FIG. 9B, an upper magnet 150a of a right side leg may have magnetic poles only on an outer side of the right side leg, and a lower magnet 150b of the right side leg may have magnetic poles only on an inner side of the right side leg. In contrast, in the core 100 of the non-limiting embodiment shown in FIG. 9B, an upper magnet 150a of a left side leg may have magnetic poles only on an inner side of the left side leg, and a lower magnet 150b of the left side leg may have magnetic poles only on an outer side of the left side leg. The magnetic poles may be arranged such that flux exits from or entering each magnetic pole flows in a direction that is opposite to a direction of flux by a coil 120.

Referring to FIG. 9B, when the magnetic poles are arranged such that an inner side of the upper magnet 150a becomes a S pole and an outer side of the upper magnet 150a becomes a N pole while an inner side of the lower magnet 150b becomes a N pole and an outer side of the lower magnet 150b becomes a S pole, a direction of magnet flux 155 may become opposite to a direction of coil flux 125. Magnet flux 155 exits from the N pole of the lower magnet 150b may flow downward along the side leg of the core 100 without flowing upward, due to an air gap 110. The magnet flux 155 flowed downward along the side leg of the core 100 may pass through the center leg and enter the S pole positioned at the inner side of the upper magnet 150a.

That the upper magnet 150a and the lower magnet 150b surround only at least a portion of the side leg 101, instead of the entire side leg 101, according to a non-limiting embodiment of the disclosure, may mean that the upper magnet 150a and the lower magnet 150b do not necessarily surround the entire side leg 101.

FIG. 9C shows a core structure having bias magnets formed on side legs, according to an embodiment of the disclosure.

Compared to the structures of the cores 100 of FIGS. 9A and 9B in which the magnetic poles of the bias magnets 150 are arranged horizontally, magnetic poles of bias magnets 150 of FIG. 9C may be arranged vertically. When the magnetic poles of the bias magnets 150 are arranged vertically such that a direction of magnet flux 155 is opposite to a direction of coil flux 125, a core 100 may have a biased core structure.

Referring to FIG. 90, S poles may be positioned at upper portions of an upper magnet 150a and a lower magnet 150b, and N poles may be positioned at lower portions of the upper magnet 150a and the lower magnet 150b.

Magnet flux 155 exits from the N pole of the lower magnet 150b may flow downward along one side leg 101 of the core 100 without flowing upward along the side leg 101, due to one air gap 110. The magnet flux 155 exits from the N pole of the lower magnet 150b may flow along the core 100, pass through a center leg 103, and enter the S pole of the upper magnet 150a. However, this is only an example embodiment, and when the winding direction of a coil 120 is reversed, the arrangement of the magnetic poles of the bias magnets 150 may also be reversed. For example, when the winding direction of the coil 120 is reversed in FIG. 9A, a direction of coil flux 125 will also be reversed, and accordingly, a direction of magnet flux 155 by the bias magnets 150 may also need to be reversed. Accordingly, N poles may be positioned at the upper portions of the upper magnet 150a and the lower magnet 150b, and S poles may be positioned at the lower portions of the upper magnet 150a and the lower magnet 150b.

FIG. 9D shows a core structure having bias magnets formed on side legs, according to an embodiment of the disclosure.

FIG. 9D is a non-limiting example embodiment in which magnetic poles of an upper magnet 150a and a lower magnet 150b as bias magnets 150 are arranged vertically, like FIG. 9C, and the upper magnet 150a and the lower magnet 150b surround only a portion of each side leg, instead of the entire side leg, like the non-limiting embodiment shown in FIG. 9B.

According to a non-limiting embodiment of the disclosure, in a core 100 of FIG. 9D, magnetic poles of an upper magnet 150a of a right side leg may be positioned only on an inner side of the right side leg, and magnetic poles of a lower magnet 150b of the right side leg may be positioned only on an outer side of the right side leg. In contrast, in the core 100 of the non-limiting embodiment shown in FIG. 9D, magnetic poles of an upper magnet 150a of a left side leg may be positioned only on an inner side of the left side leg, and magnetic poles of a lower magnet 150b of the left side leg may be positioned only on an outer side of the right side leg. The magnetic poles may be arranged such that flux exits from or entering each magnetic pole flows in a direction that is opposite to a direction of flux by a coil 120.

Referring to FIG. 9D, when the magnetic poles are arranged such that an upper portion of the upper magnet 150a becomes a S pole and a lower portion of the upper magnet 150a becomes a N pole while a lower portion of the lower magnet 150b becomes a N pole and an upper portion of the lower magnet 150b becomes a S pole, a direction of magnet flux 155 may become opposite to a direction of coil flux 125. Magnet flux 155 exits from the N pole of the lower magnet 150b may flow downward along one side leg 101 of the core 100 without flowing upward, due to one air gap 110. The magnet flux 155 flowed downward along the side leg 101 of the core 100 may pass through a center leg 103 and enter the S pole positioned at the upper portion of the upper magnet 150a.

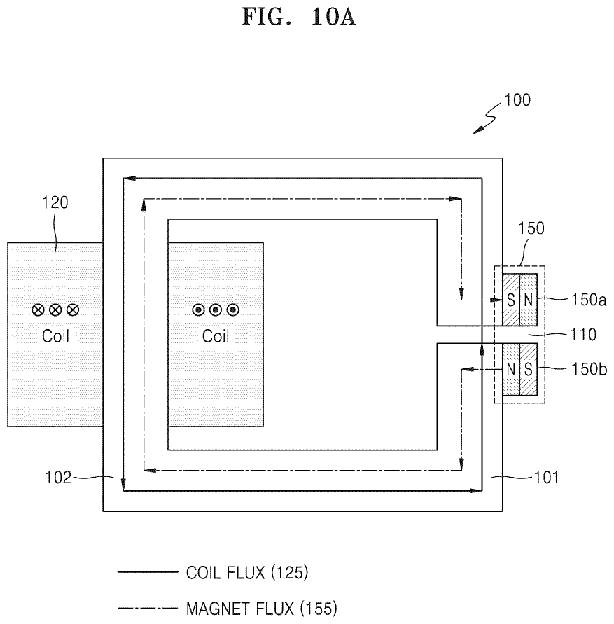

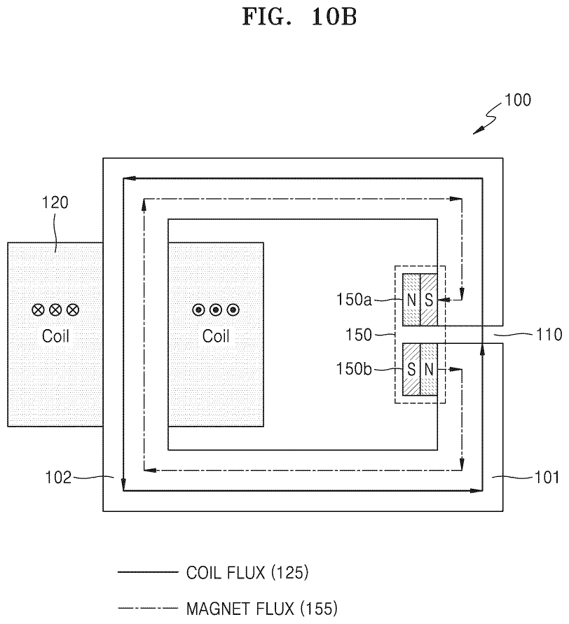

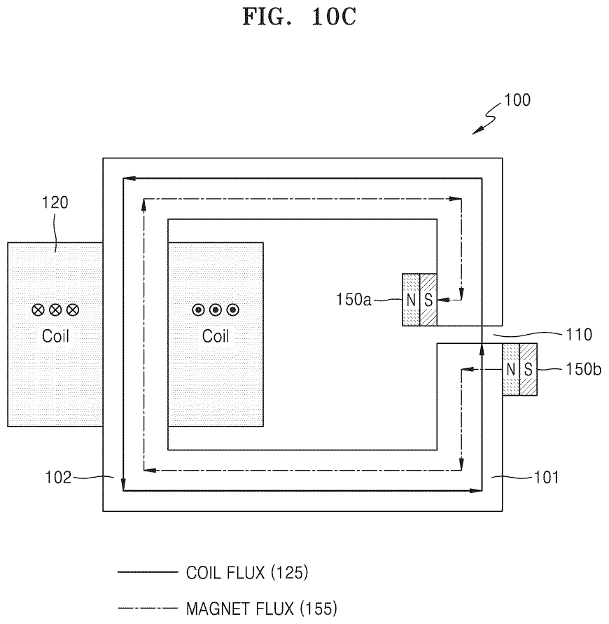

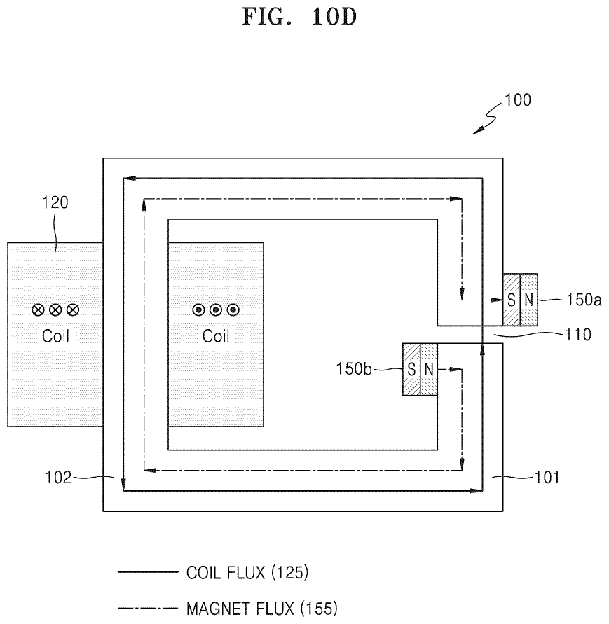

FIG. 10A shows a structure in which bias magnets are attached to a rectangular core, according to an embodiment of the disclosure.

The cores of FIGS. 7 and 8A to 9D may be cores including center legs, and cores 100 of FIGS. 10A to 10D may be rectangular cores excluding center legs.

According to an embodiment of the disclosure, a core 100 of FIG. 10A may include a first leg 101 including an air gap 110, and a second leg 102 around which a coil 120 is wound. Bias magnets 150 with the air gap 110 in between may be attached to the core 100 above and below the air gap 110. A magnet positioned above the air gap 110 is referred to as an upper magnet 150a, and a magnet positioned below the air gap 110 is referred to as a lower magnet 150b. Magnetic poles of the bias magnets 150 may be arranged such that a direction of magnet flux 155 by the bias magnets 150 is opposite to a direction of coil flux by the coil 120, as described above.

In FIG. 10A, because coil flux 125 flows in a counterclockwise direction by the coil 120, magnet flux 155 may need to flow in a clockwise direction. Accordingly, an inner side of the upper magnet 150a of the bias magnets 150 may become a S pole and an outer side of the upper magnet 150a may become a N pole, while an inner side of the lower magnet 150b may become a N pole and an outer side of the lower magnet 150b may become a S pole.

In the cores 100 of FIGS. 8A to 8D, the magnetic poles of the bias magnets 150 may be arranged such that the bias magnets 150 substantially surround both sides or all four sides of the center leg. In contrast, in a non-limiting embodiment shown in FIG. 10A, because flux flowing through the first leg 101 flows toward the second leg 102, the upper magnet 150a and the lower magnet 150b may be attached only to an outer surface of the first leg 101 to form magnet flux 155 as shown in FIG. 10A.

FIG. 10A shows a non-limiting embodiment in which the upper magnet 150a and the lower magnet 150b are attached only to the outer surface of the first leg 101. However, due to characteristics of the rectangular core, the upper magnet 150a and the lower magnet 150b may be attached only to an inner surface of the first leg 101 to form desired magnet flux 155.

This example is shown in FIG. 10B.

FIG. 10B shows a structure in which bias magnets are attached to a rectangular core, according to an embodiment of the disclosure.

A core structure of FIG. 10B may be different from the structure of FIG. 10A in that an upper magnet 150a and a lower magnet 150b of bias magnets 150 are arranged on an inner side of a first leg 101 with an air gap 110 in between. Unlike the core structure of FIG. 10B, any of the upper magnet 150a or the lower magnet 150b may be positioned on an outer side of the first leg 101 and another one may be positioned on the inner side of the first leg 101. These examples are shown in FIGS. 10C and 10D.

FIG. 10C shows a structure in which bias magnets are attached to a rectangular core, according to an embodiment of the disclosure.

In a core structure of FIG. 10C, an upper magnet 150a may be positioned on an inner side of a first leg 101, and a lower magnet 150b may be positioned on an outer side of the first leg 101. As described above, magnetic poles of the upper magnet 150a and the lower magnet 150b may be arranged such that a direction of magnet flux 155 is opposite to a direction of coil flux 125.

FIG. 10D shows a structure in which bias magnets are attached to a rectangular core, according to an embodiment of the disclosure.

In a core structure of FIG. 10D, an upper magnet 150a may be positioned on an outer side of a first leg 101, and a lower magnet 150b may be positioned on an inner side of the first leg 101, contrary to FIG. 10C. However, in FIGS. 10A to 10D, it is preferable to understand that the outer sides and inner sides are at least a part of a total length surrounding the first leg 101. As seen from FIGS. 10A to 10D, in a rectangular core structure, magnetic poles of an upper magnet 150a may be positioned on at least a portion of a first leg 101 above an air gap 110, and magnetic poles of a lower magnet 150b may be positioned on at least a portion of the first leg 101 below the air gap 110. In other words, any core structure in which magnetic poles are arranged on at least a portion of a circumference of a first leg 101 to form magnet flux 155 of FIGS. 10A to 10D, as well as the example in which magnetic poles are arranged on an inner or outer side of a first leg 101, as shown in FIGS. 10A to 10D, may function as a biased core. A cross-sectional structure in which the bias magnets 150 surround the core at the first leg 101 will be described in detail, below.

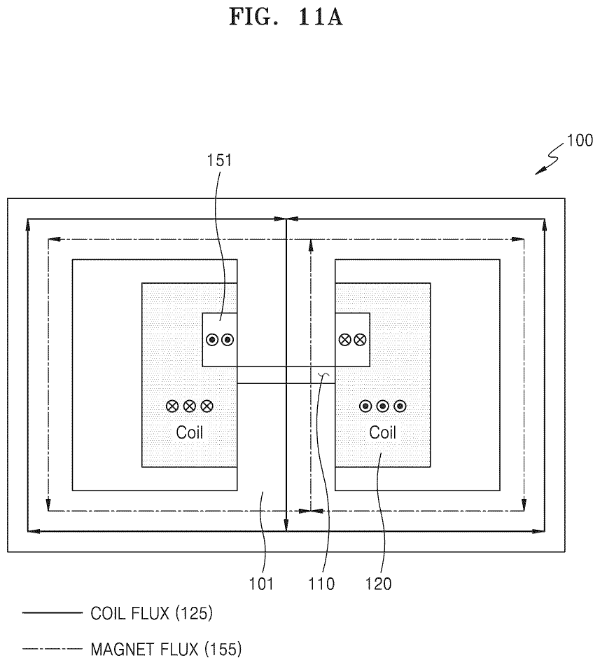

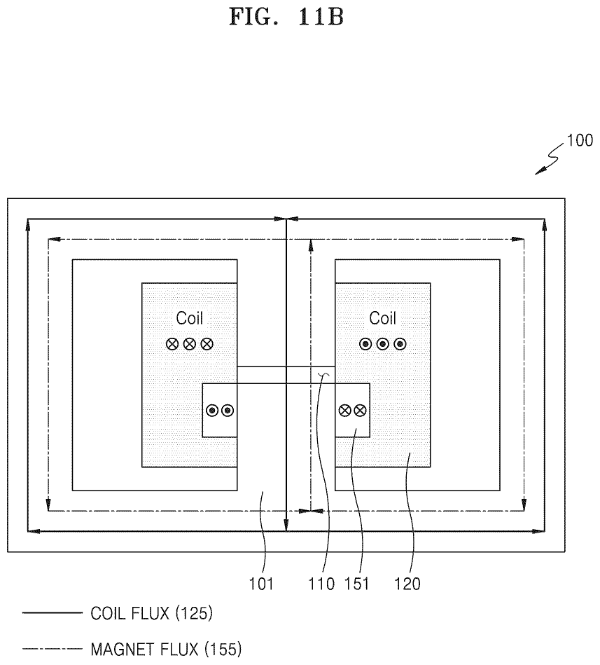

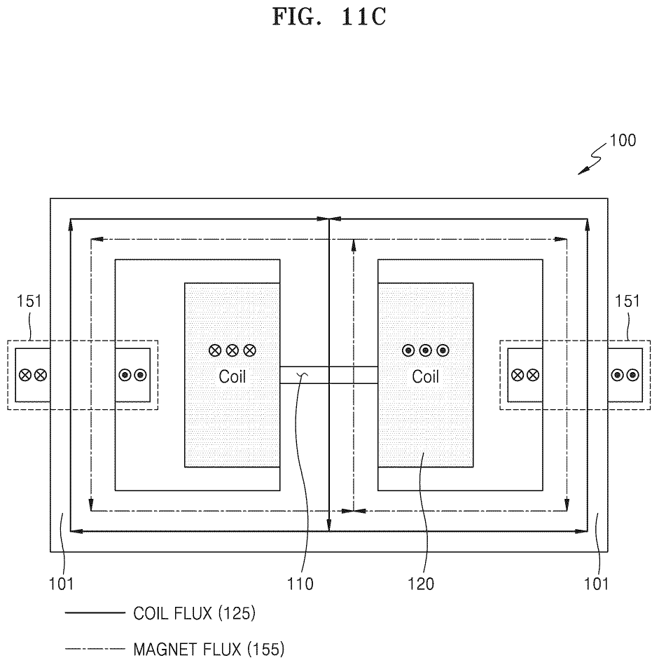

FIG. 11A shows a core structure to which bias magnets by coils are attached, according to an embodiment of the disclosure.

The cores 100 of FIGS. 8A to 10D may use the bias magnets 150 to operate as biased cores. However, each bias magnet 150 may be replaced with a bias electromagnet 151 by an electromagnet coil.

According to an embodiment of the disclosure, FIG. 11A shows a core in which a bias electromagnet 151 by an electromagnet coil is used instead of the bias magnets 150. A direction of magnet flux 155 by the bias electromagnet 151 may need to be opposite to a direction of flux by a coil 120, like the above-described case of using the bias magnets 150. According to an embodiment of the disclosure, the bias electromagnet 151 may be located above an air gap 110. An electromagnetic coil configuring the bias electromagnet 151 may be wound in a direction that is opposite to a winding direction of the coil 120, in consideration of a direction of flux.

Unlike the cases of FIGS. 8A to 8D in which the bias magnets 150 are used above and below the air gaps 110, the bias electromagnet 151 may be located only above or below the air gap 110 to form a flux path shown in a non-limiting embodiment shown in FIG. 11A.

In a core 100 of FIG. 11A, because a first leg 101 is a center leg and the air gap 110 is located in the center leg, an electromagnetic coil may be wound above or below the air gap 110 to form the bias electromagnet 151.

FIG. 11B shows a core structure to which bias magnets by coils are attached, according to an embodiment of the disclosure.

In FIG. 11A, the bias electromagnet 151 may be located above the air gap 110, and FIG. 11B shows an example in which a bias electromagnet 151 is located below an air gap 110. Even when the bias electromagnet 151 is located below the air gap 110, a biased core may be formed in the same way as in the case of the core 100 in FIG. 11A.

FIG. 11A shows a core structure to which bias magnets by coils are attached, according to an embodiment of the disclosure.

FIG. 11C shows a core in which bias electromagnets 151 are located on both side legs, instead of a center leg with an air gap, according to an embodiment of the disclosure. As described above, a coil 120 of a bias electromagnet 151 may be positioned at any location of a core 100 as long as the coil 120 is wound to form magnet flux 155 in a direction that is opposite to a direction of coil flux 125 by a coil 120 of the core 100. In FIG. 11C, the bias electromagnets 151 may be located on both side legs without an air gap 110. In FIG. 11C, the both side legs may be first legs 101, according to an embodiment of the disclosure.

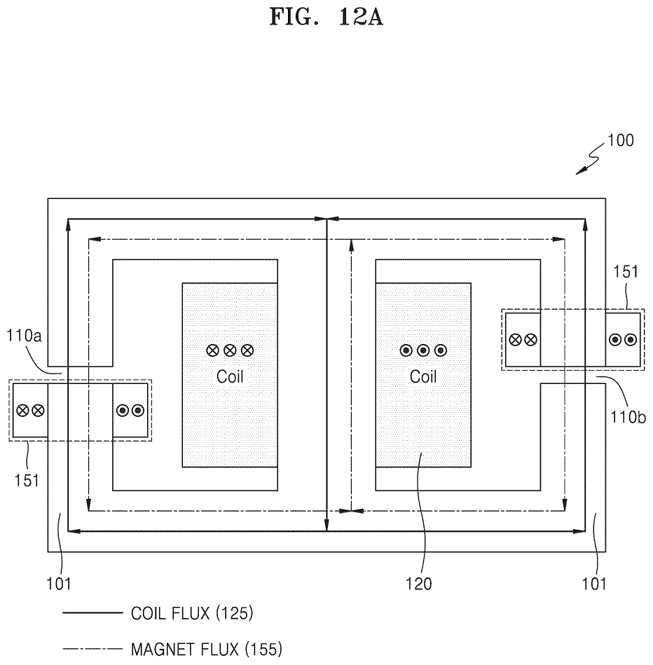

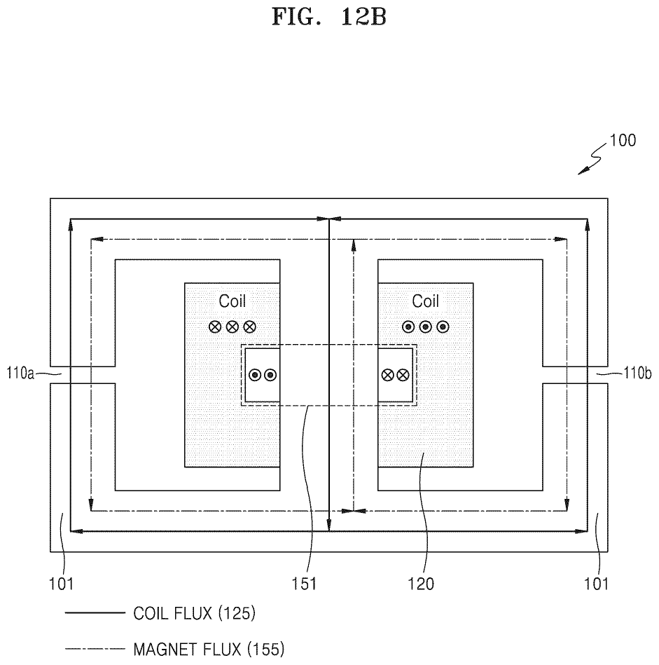

FIG. 12A shows a core structure to which bias magnets by coils are attached, according to an embodiment of the disclosure.

A core 100 of FIG. 12A may have a structure in which air gaps are located in both sides, like the cores 100 of FIGS. 9A to 9D.

The core 100 may include a left air gap 100a included in a left side leg and a right air gap 110b included in a right side leg. According to an embodiment of the disclosure, a bias electromagnet 151 may be arranged on each of both side legs which are first legs 101. The bias electromagnet 151 may be an electromagnet formed by a coil, which is not a magnet having magnetic poles as described above with reference to FIGS. 11A and 11B. The coil of the bias electromagnet 151 may be wound such that magnet flux 155 is formed in a direction that is opposite to a direction of coil flux 125 by a coil 120 of the core 100. In FIG. 12A, a right bias electromagnet 151 is shown to be wound above the right air gap 100b and a left bias electromagnet 151 is shown to be wound below the left air gap 110a. However, this is only an example embodiment, and the bias electromagnet 151 may be positioned at any location of the core 100 as long as the bias electromagnet 151 is theoretically capable of generating magnet flux 155 in a direction that is opposite to a direction of coil flux by the coil 120. Accordingly, the bias electromagnet 151 may be positioned at any location of the core 100, as shown in a non-limiting embodiment of FIG. 12B, compared to the cases of FIGS. 9A to 9D in which the bias magnets 150 are located around the air gaps 110.

FIG. 12B shows a core structure to which a bias magnet by a coil is attached, according to an embodiment of the disclosure.

Referring to FIG. 12B, according to a non-limiting embodiment of the disclosure, a bias electromagnet 151 by an electromagnetic coil may be located on a center leg having no air gap 110. A direction of magnet flux 155 formed by the bias electromagnet 151 may be opposite to a direction of coil flux 125 by a coil 120. In this case, the center leg may be a first leg 101 where the bias electromagnet 151 is located.

FIGS. 12A and 12B are only examples, and as described above, the bias electromagnet 151 by the electromagnetic coil may be positioned at any location capable of forming magnet flux 155 in a direction that is opposite to a direction of flux by the coil 120.

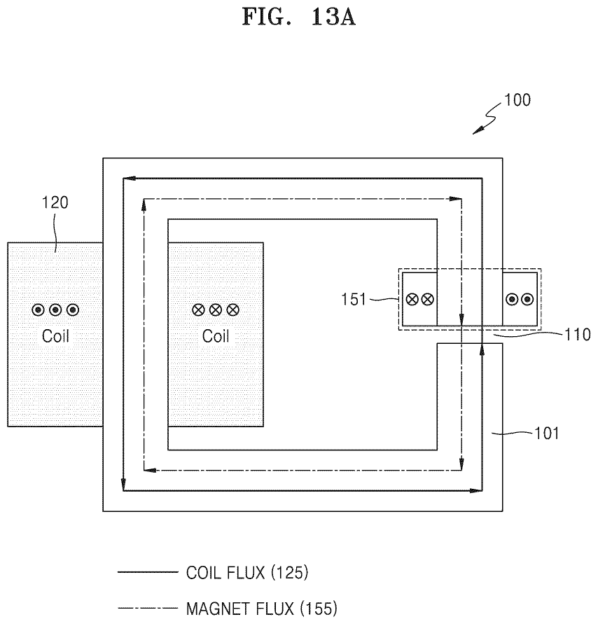

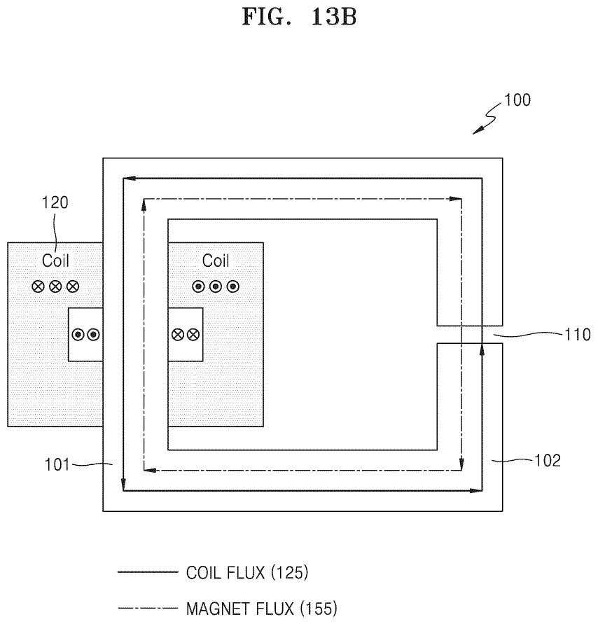

FIG. 13A shows a core structure to which a bias magnet by a coil is attached, according to a non-limiting embodiment of the disclosure.

A core 100 of FIG. 13A may have a structure in which an air gap 110 is located in a first leg 101 which is one side leg of a rectangular core, like the cores of FIGS. 10A to 10D. According to an embodiment of the disclosure, a bias electromagnet 151 may be positioned on the first leg 101 with the air gap 110. In this case, the bias electromagnet 151 may be positioned above or below the air gap 110. Like the above-described example, a coil of the bias electromagnet 151 may be wound to form magnet flux 155 in a direction that is opposite to a direction of coil flux 125 by a coil 120 of the core 100. Also, the bias electromagnet 151 may be positioned at any location of the core 100 as long as the bias electromagnet 151 is theoretically capable of generating magnet flux 155 in a direction that is opposite to a direction of coil flux by the coil 120. Accordingly, unlike the bias magnets 150 of FIGS. 10A to 10D located around the air gaps 110, the bias electromagnet 151 may be positioned at any location of the core 100, as shown in FIG. 13B.

FIG. 13B shows a core structure to which a bias magnet by a coil is attached, according to an embodiment of the disclosure.

Referring to FIG. 13B, a bias electromagnet 151 by an electromagnetic coil may be located on a side leg without an air gap 110, according to an embodiment of the disclosure. Accordingly, in this example, the side leg on which the bias electromagnet 151 is located may become a first leg 101. Accordingly, both a coil 120 that generates coil flux 125 and the bias electromagnet 151 that generates magnet flux 155 may be wound on the first leg 101. A direction of the magnet flux 155 formed by the bias electromagnet 151 may be opposite to a direction of the coil flux 125 by the coil 120.

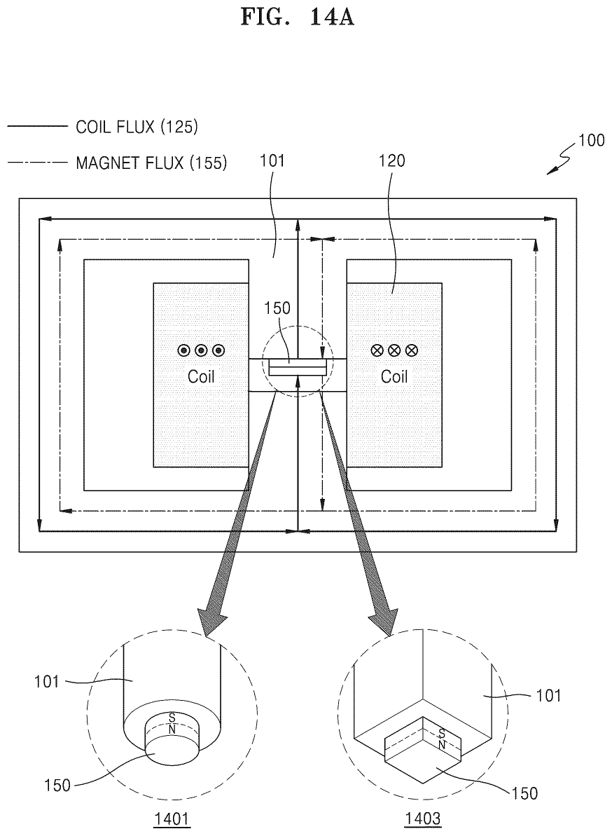

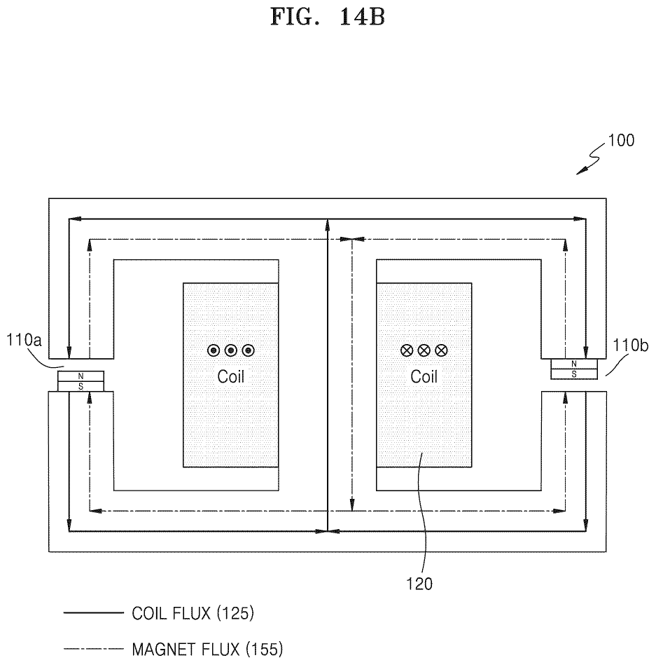

FIG. 14A shows a core structure to which a bias magnet is attached, according to a non-limiting embodiment of the disclosure.

FIG. 14A shows a structure of a core 100 in which a bias magnet 150 is attached on a leg cross-section of a core 100, according to a non-limiting embodiment of the disclosure. While the bias magnets 150 disclosed in FIGS. 8A to 13B are not located on paths of coil flux 125, the bias magnet 150 of FIG. 14A may be located on a path of coil flux 125. According to a non-limiting embodiment of the disclosure, the bias magnet 150 of FIG. 14A may be located on cross-sections of a first leg 101, which face each other with an air gap 110 in between.

With continued reference to FIG. 14A, perspective views 1401 and 1403 show cross-sections to which bias magnets 150 are attached in the case in which the first leg 101 has a circular shape and the case in which the first leg 101 has a rectangular shape. In FIG. 14A, the bias magnet 150 may be positioned on any or both of the cross-sections of the first leg 101 with the air gap 110 in between.

According to a non-limiting embodiment of the disclosure, as shown in views 1401 and 1403, a cross-sectional area of the bias magnet 150 may be smaller than a cross-sectional area of the first leg 101. According to a non-limiting embodiment of the disclosure, the cross-sectional area of the bias magnet 150 may be smaller than the cross-sectional area of the first leg 101, and the bias magnet 150 may be located at an exact center of the cross-section of the first leg 101, as shown in 1401 and 1403.

The bias magnet 150 may generate magnet flux 155 in a direction that is opposite to a direction of coil flux 125 by a coil 120, as in the above-described embodiment.

FIG. 14B shows a core structure to which bias magnets are attached, according to an embodiment of the disclosure.

In FIG. 14B, a core 100 may include air gaps in both side legs, instead of including an air gap in a center leg. According to an embodiment of the disclosure, a bias magnet 150 may be located on a cross-section of a left side leg including a left air gap 110a, and also, another bias magnet 150 may be located on a cross-section of a right side leg including a right air gap 110b. Like FIG. 14A, a cross-sectional area of each bias magnet 150 may be smaller than a cross-sectional area of each side leg. According to a non-limiting embodiment of the disclosure, the cross-sectional area of the bias magnet 150 may be smaller than the cross-sectional area of the side leg, and the bias magnet 150 may be located at an exact center of the cross-section of the side leg.

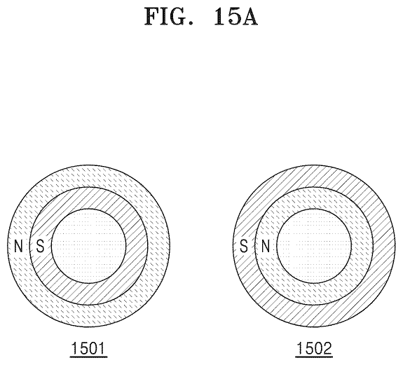

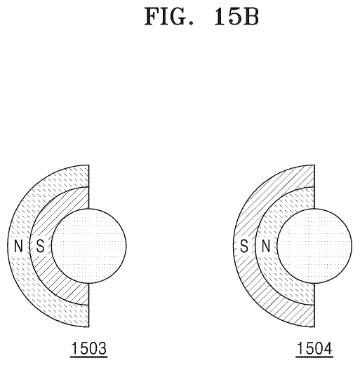

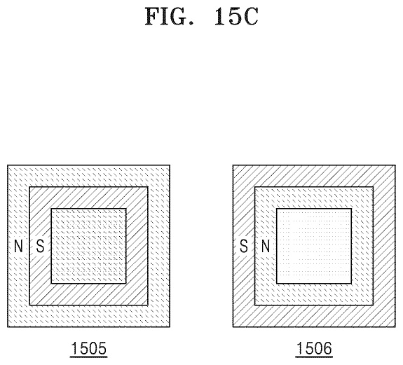

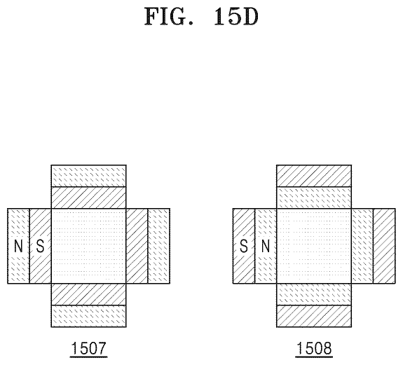

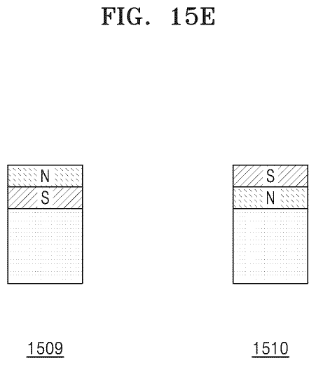

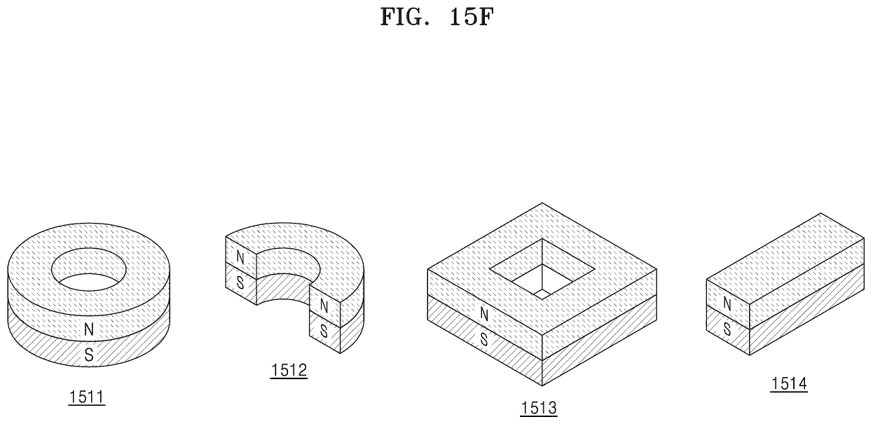

FIG. 15A is cross-sectional views of bias magnets according to a non-limiting embodiment of the disclosure.

FIG. 15A shows cross-sections of bias magnets 150. Because the bias magnets 150 of FIG. 15A have circular shapes, legs of cores surrounded by the bias magnets 150 may also need to have circular shapes. An outer pole of a magnet 1501 may be a N pole and an inner pole thereof may be a S pole. An outer pole of a magnet 1502 may be a S pole and an inner pole thereof may be a N pole. According to a non-limiting embodiment of the disclosure, when the center leg of the core 100 of FIG. 8A has a circular cross-section, the magnet 1501 of the bias magnets 150 of FIG. 15A may be used as the lower magnet 150b and the magnet 1502 may be used as the upper magnet 150a. Alternatively, when the center leg of the core 100 of FIG. 8B has a circular cross-section, the magnet 1501 of the bias magnets 150 of FIG. 15A may be used as the upper magnet 150a and the magnet 1502 may be used as the lower magnet 150b. Alternatively, when the first leg 101 of the core 100 of FIG. 9A has a circular cross-section, the magnet 1501 of the bias magnets 150 of FIG. 15A may be used as the upper magnet 150a and the magnet 1502 may be used as the lower magnet 150b.

FIG. 15B is cross-sectional views of bias magnets according to a non-limiting embodiment of the disclosure.

FIG. 15B shows cross-sections of bias magnets 150. The bias magnets 150 of FIG. 15B may be the same as the bias magnets 150 of FIG. 15A in that legs of cores surrounded by the bias magnets 150 are circular, and may be different from the bias magnets 150 of FIG. 15A in that the bias magnets 150 are not perfectly circular. An outer pole of a magnet 1503 may be a N pole and an inner pole thereof may be a S pole. An outer pole of a magnet 1504 may be a S pole and an inner pole thereof may be a N pole. The bias magnets 150 of FIG. 15B having semi-circular shapes may be only an example, and may be replaced by any bias magnets 150 capable of surrounding circular core legs although the bias magnets 150 do not have completely circular shapes. According to an embodiment of the disclosure, when the center leg of the core 100 of FIG. 8A has a circular cross-section, the magnet 1503 of the bias magnets 150 of FIG. 15B may be used as the lower magnet 150b, and the magnet 1504 may be used as the upper magnet 150a. In this case, the bias magnets 150 may surround only a portion of the center leg of FIG. 8A, instead of the entire center leg. Also, in the cores 100 of FIGS. 8B, 9A, 9B, and 10A to 10D, when the legs of the cores 100 surrounded by the bias magnets 150 have circular cross-sections, the bias magnets 150 of FIG. 15B may be used.

FIG. 15C is cross-sectional views of bias magnets according to a non-limiting embodiment of the disclosure.

FIG. 15C shows cross-sections of bias magnets 150. Because the bias magnets 150 of FIG. 15C have rectangular shapes, legs of cores surrounded by the bias magnets 150 may need to be rectangular. An outer pole of a magnet 1505 may be a N pole and an inner pole thereof may be a S pole. An outer pole of a magnet 1506 may be a S pole and an inner pole thereof may be a N pole. According to an embodiment of the disclosure, when the center leg of the core 100 of FIG. 8A has a rectangular cross-section, the magnet 1505 of the bias magnets 150 of FIG. 15C may be used as the lower magnet 150b and the magnet 1506 may be used as the upper magnet 150a. Alternatively, when the center leg of the core 100 of FIG. 8B has a rectangular cross-section, the magnet 1505 of the bias magnets 150 of FIG. 15C may be used as the upper magnet 150a and the magnet 1506 may be used as the lower magnet 150b. Alternatively, when the first leg 101 of the core 100 of FIG. 9A has a rectangular cross-section, the magnet 1505 of the bias magnets 150 of FIG. 15C may be used as the upper magnet 150a and the magnet 1506 may be used as the lower magnet 150b.

FIG. 15D is cross-sectional views of bias magnets according to a non-limiting embodiment of the disclosure.

Bias magnets 150 of FIG. 15D may have rectangular shapes, and therefore, legs of cores surrounded by the bias magnets 150 may also need to be rectangular. While each bias magnet 150 of FIG. 15C surrounds the entire rectangular core leg, the bias magnets 150 of FIG. 15D may be provided as four pieces and attached respectively to four sides of a rectangular core leg. Accordingly, in FIG. 15D, the bias magnets 150 are shown to be attached to all the four sides of the rectangular core leg, however, this is only an example embodiment. The bias magnets 150 may be attached only to some (one side, two sides, or three sides) of the four sides.

An outer pole of a magnet 1507 may be a N pole and an inner pole thereof may be a S pole. An outer pole of a magnet 1508 may be a S pole and an inner pole thereof may be a N pole. According to an embodiment of the disclosure, when the center leg of the core 100 of FIG. 8A has a rectangular cross-section, the magnet 1507 of the bias magnets 150 of FIG. 15D may be used as the lower magnet 150b and the magnet 1508 may be used as the upper magnet 150a. Alternatively, when the center leg of the core 100 of FIG. 8B has a rectangular cross-section, the magnet 1507 of the bias magnets 150 of FIG. 15D may be used as the upper magnet 150a and the magnet 1508 may be used as the lower magnet 150b. Alternatively, when the first leg 101 of the core 100 of FIG. 9A has a rectangular cross-section, the magnet 1507 of the bias magnets 150 of FIG. 15D may be used as the upper magnet 150a and the magnet 1508 may be used as the lower magnet 150b.

In the case in which the bias magnets 150 of FIG. 15D are attached to two opposite sides of a core leg or three or less sides of the core leg although the bias magnets 150 are not attached to all four sides of the core leg, the bias magnets 150 of FIG. 15D may be applied to all the bias magnets 150 of FIGS. 8A, 8B, 9A, 9B, and 10A to 10D.

FIG. 15E is cross-sectional views of bias magnets according to a non-limiting embodiment of the disclosure.

A bias magnet 150 of FIG. 15E may be applied to the case in which a leg of core, surrounded by the bias magnet 150, is rectangular. However, the bias magnet 150 of FIG. 15E may be different from the bias magnets 150 of FIG. 15D in that while the four bias magnets 150 of FIG. 15D are attached to all four sides of a core leg which is rectangular, the bias magnet of FIG. 15E is attached to any one side of a core leg which is rectangular.

An outer pole of a magnet 1509 may be a N pole and an inner pole thereof may be a S pole. An outer pole of a magnet 1510 may be a S pole and an inner pole thereof may be a N pole. According to an embodiment of the disclosure, when the first leg 101 of the core 100 of FIG. 9A has a rectangular cross-section, the magnet 1509 of the bias magnets 150 of FIG. 15E may be used as the upper magnet 150a and the magnet 1510 may be used as the lower magnet 150b.

The bias magnets 150 of FIG. 15E may be applied to all the bias magnets 150 of FIGS. 8A, 8B, 9A, 9B, and 10A to 10D.

FIG. 15F is perspective views of bias magnets according to a non-limiting embodiment of the disclosure.

The bias magnets of FIGS. 15A to 15E may be attached horizontally to the legs of the cores 100, and the bias magnets of FIG. 15F may be attached vertically (N and S poles are arranged in a direction parallel to the legs) to the legs of the cores 100.

Referring to FIG. 15F, magnets 1511 and 1512 may be bias magnets capable of being used when the legs of the cores 100 are circular. Magnets 1513 and 1514 may be bias magnets capable of being used when the legs of the cores 100 are rectangular.

According to an embodiment of the disclosure, the magnets 1511 and 1513 may be bias magnets surrounding the entire legs of the cores 100. In contrast, the magnets 1512 and 1514 may be magnets surrounding portions of the legs of the cores 100. Examples to which the bias magnets surrounding the entire legs of the cores 100 and the magnets surrounding the portions of the legs of the cores 100 are applied have been described in detail with reference to FIGS. 15A to 15E, and therefore, descriptions thereof will be omitted.

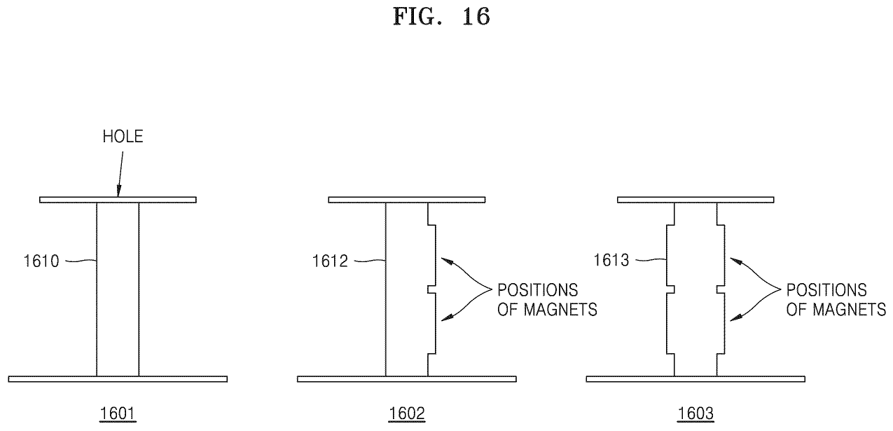

FIG. 16 shows bobbin structures (also referred to as a “bobbin”) according to an embodiment of the disclosure.

A bobbin may be a type of tub around which a coil is wound and may be a structure used to support a core 100 and a bias magnet 150. For example, a hole in which a leg (for example, a center leg) of the core 100 is inserted may be provided in a center portion of a bobbin 1601 of FIG. 16. For example, a center leg of an EI core 100 may be inserted in the hole, and a coil may be wound around a tube pillar 1610 of the bobbin.

Referring to FIG. 16, in the bobbin 1601 which is a basic bobbin, the leg of the core 100 may be inserted in the hole of the tube pillar 1610 and the coil may be wound around the tube pillar 1610. Bobbin tube pillars of FIG. 16 may have circular cross-sections or rectangular cross-sections according to shapes of cores 100.

A bobbin 1602 may include a space where a bias magnet 150 is attached and supported around a leg of a core 100, according to an embodiment of the disclosure. A tube pillar 1612 of the bobbin 1602 may be provided with a space where a bias magnet 150 surrounding at least a portion of the leg of the core 100 is attached. For example, when magnets are attached only to some portions of the rectangular cross-sections as shown in FIGS. 15B and 15D, the bias magnets 1512 and 1514 of FIGS. 15E and 15F may be positioned in the space.

A bobbin 1603 may include a space where a bias magnet is attached around a leg of a core 100, according to an embodiment of the disclosure. A tube pillar 1613 of the bobbin 1603 may be provided with a space where a bias magnet 150 surrounding the entire leg of the core 100 is attached. For example, when magnets are attached to all sides of the cross-sections as shown in FIGS. 15A, 15C and 15D, the bias magnets 1511 and 1513 of FIG. 15F may be positioned in the space.

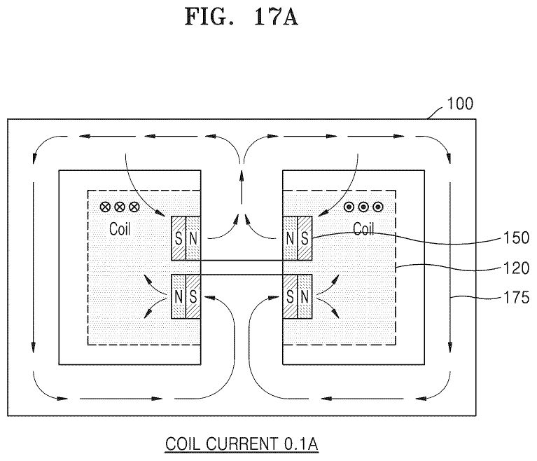

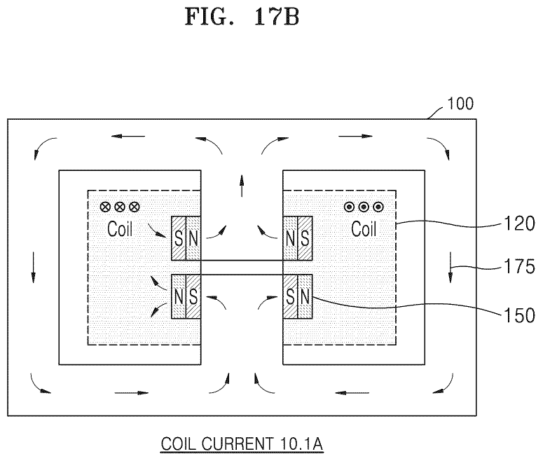

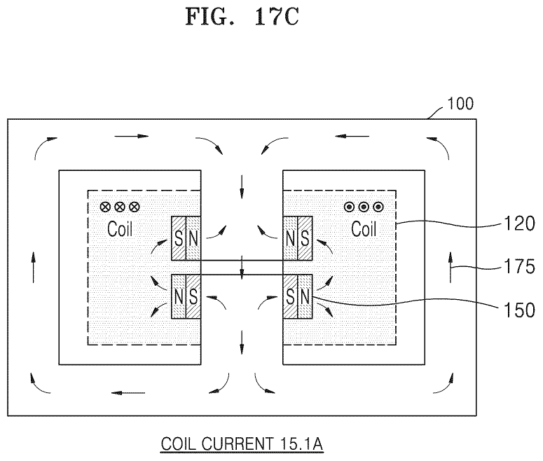

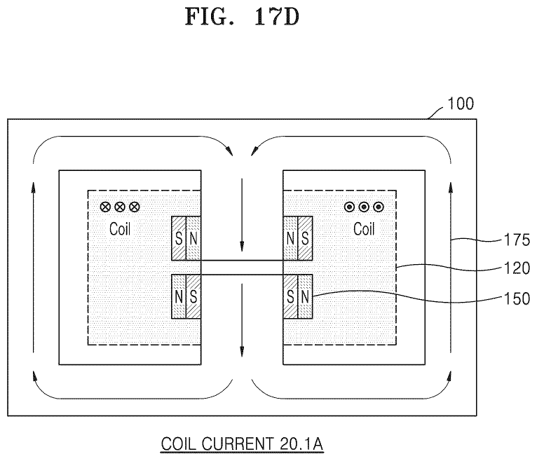

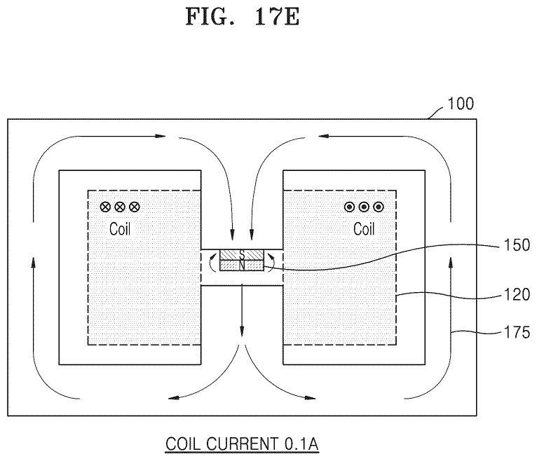

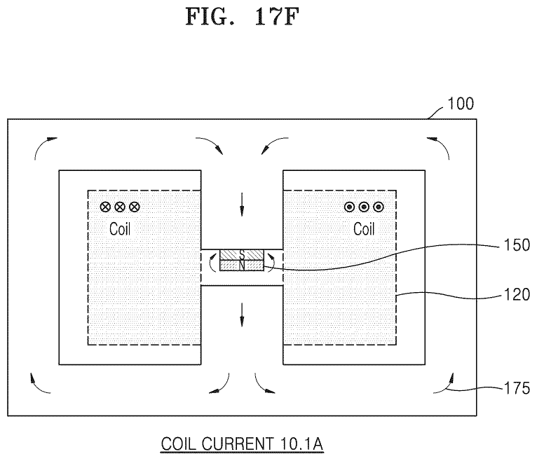

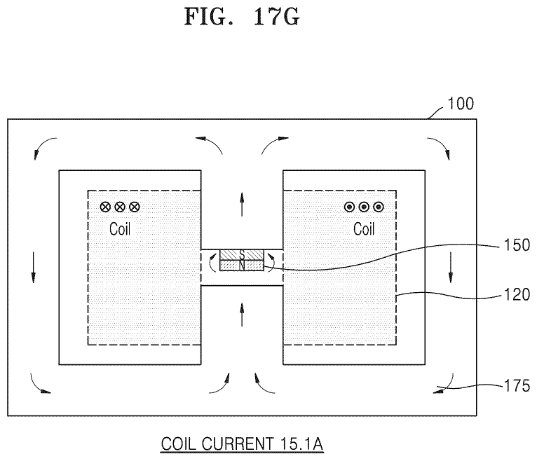

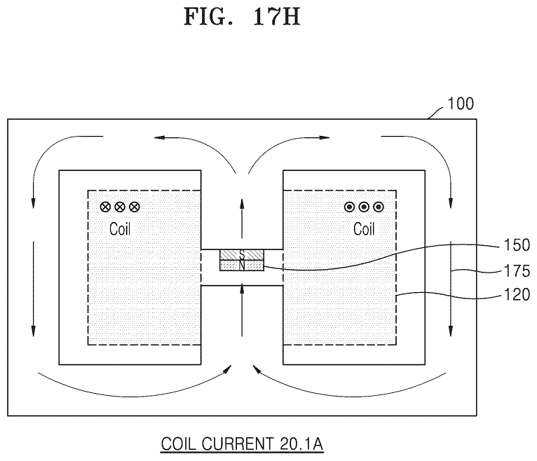

FIG. 17A is a diagram showing flux changes according to changes of coil current in the case in which bias magnets are installed on a core center leg, according to an embodiment of the disclosure.

FIGS. 17A to 17D briefly show results (changes of flux) of simulations in which flux of a core 100 changes according to a change in current of a coil 120.

Referring to FIG. 17A, for example, a change in flux when 0.1 Amps (0.1 A) of current flows through the coil 120 in the structure of the core 100 of FIG. 8A is shown. A magnitude (strength) of flux flowing through the core 100 shown in FIGS. 17A to 17D may be proportional to a length of an arrow line corresponding to core flux 175. The core flux 175 may be a vector sum of coil flux by the coil 120 and magnet flux by the bias magnets 150.

In FIG. 17A, because coil (120) current currently flowing through the core 100 is small, coil flux may be little generated, and a major part of the core flux 175 flowing through the core 100 may be flux by the bias magnets 150. Accordingly, when current of the coil 120 is very small, flux by the N and S poles of the bias magnets 150 may become main flux forming the core flux 175.

FIG. 17B is a diagram showing flux changes according to changes of coil current in the case in which bias magnets are installed on a core center leg, according to an embodiment of the disclosure.

Referring to FIG. 17B, a flux change in the core 100 when a coil current of 10.1 A flows through the coil 120 is shown.

In core flux 175 of FIG. 17B, magnet flux by the bias magnets 150 may also still be greater than coil flux by the coil 120, as in FIG. 17A. However, compared to the case of FIG. 17A, because current flowing through the coil 120 has increased, strength of coil flux by the coil 120 may increase, and accordingly, magnet flux by the bias magnets 150 may relatively decrease. Accordingly, it may be seen that strength (length of an arrow) of core flux 175 is smaller than in the case of FIG. 17A.

FIG. 17C is a diagram showing flux changes according to changes of coil current in the case in which bias magnets are installed on a core center leg, according to an embodiment of the disclosure.

Referring to FIG. 17C, when a current of 15.1 A flows through the coil 120, a magnitude of coil flux by the current flowing through the coil 120 may become greater than a magnitude of magnet flux. Accordingly, a flux direction according to the coil flux by the current flowing through the coil 120 may be formed. A flux change in the core 100 from FIG. 17B to FIG. 17C may correspond to a movement of a B value from the fourth quadrant to the first quadrant in the second BH curve 12 of FIG. 4.

FIG. 17D is a diagram showing flux changes according to changes of coil current in the case in which bias magnets are installed on a core center leg, according to an embodiment of the disclosure.

Referring to FIG. 17D, when a current of 20.1 A flows through the coil 120, coil flux by the current flowing through the coil 120 may become main flux forming core flux 175. It may be seen that strength of the core flux 175 of FIG. 17D is greater than that of the core flux 175 of FIG. 17C. As shown in FIG. 17D, an increase in strength of coil flux may correspond to approaching the saturation region in the first quadrant of the second BH curve 12 of FIG. 4. However, because the bias magnets 150 are applied, the core 100 will not be saturated although a current of 20.1 A flows through the coil 120.

FIG. 17E is a diagram showing flux changes according to changes of coil current in the case in which a bias magnet is installed on a cross-section of a core center leg, according to an embodiment of the disclosure.

FIGS. 17E to 17H briefly show results (changes of flux) of simulations in which a flux of a core 100 changes according to a change in a current flowing through a coil 120.

Changes in flux of FIGS. 17E to 17H may be basically the same as those of FIGS. 17A to 17D except that a bias magnet 150 is installed on a cross-section of a center leg of a core 100.

Referring to FIG. 17E, a change in flux when a current of 0.1 A flows through the coil 120 in the structure of the core 100 of FIG. 14A is shown. A magnitude (strength) of core flux 175 flowing through the core 100 shown in FIGS. 17A to 17D may be proportional to a length of an arrow line. The core flux 175 may be a vector sum of coil flux by the coil 120 and magnet flux by the bias magnet 150.

In FIG. 17E, because the coil (120) current currently flowing through the core 100 is small, coil flux may be little generated, and a major part of the core flux 175 flowing through the core 100 may be flux by the bias magnet 150. Accordingly, when current of the coil 120 is very small current such as 0.1 A, for example, flux by the N and S poles of the bias magnet 150 may become main flux forming the core flux 175.

FIG. 17F is a diagram showing flux changes according to changes of coil current in the case in which a bias magnet is installed on a cross-section of a core center leg, according to an embodiment of the disclosure.

Referring to FIG. 17F, a change of core flux 175 when current of 10.1 A flows through the coil 120 is shown. As shown in FIG. 17F, magnet flux by the bias magnet 150 may also still be greater than coil flux by the coil 120, as in FIG. 17E. However, compared to the case of FIG. 17E, because current flowing through the coil 120 increases, strength of coil flux by the coil 120 may relatively increase, and accordingly, a magnitude of magnet flux by the bias magnet 150 may relatively decrease. Accordingly, it may be seen that strength (length of an arrow) of the core flux 175 is smaller than in the case of FIG. 17E.

FIG. 17G is a diagram showing flux changes according to changes of coil current in the case in which a bias magnet is installed on a cross-section of a core center leg, according to an embodiment of the disclosure.

Referring to FIG. 17G, when a current of 15.1 A flows through the coil 120, a magnitude of coil flux by the current flowing through the coil 120 may be greater than a magnitude of magnet flux. Accordingly, a flux direction according to the coil flux by the current flowing through the coil 120 may become a direction of core flux 175. A change in flux in the core 100 from FIG. 17F to FIG. 17G may correspond to a movement of a B value from the fourth quadrant to the first quadrant in the second BH curve 12 of FIG. 4.

FIG. 17H is a diagram showing flux changes according to changes of coil current in the case in which a bias magnet is installed on a cross-section of a core center leg, according to an embodiment of the disclosure.

Referring to FIG. 17H, when current of 20.1 A flows through the coil 120, coil flux by the current flowing through the coil 120 may become main flux forming core flux 175. It may be seen that strength of the core flux 175 of FIG. 17H is greater than that of the core flux 175 of FIG. 17G. As shown in FIG. 17H, an increase in strength of coil flux may correspond to approaching the saturation region in the first quadrant of the second BH curve 12 of FIG. 4. However, because the bias magnet 150 is applied, the core 100 will not be saturated although a current of 20.1 A flows through the coil 120.

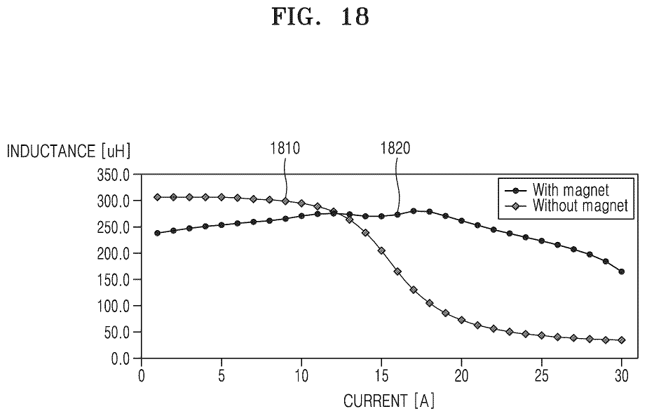

FIG. 18 is a graph showing a relationship of inductance with respect to current in the case in which a bias magnet according to an embodiment of the disclosure is applied to a core.

Referring to FIG. 18, a first inductance graph 1810 showing inductance of a core without a bias magnet 150 and a second inductance graph 1820 showing inductance of a core with a bias magnet 150 are compared.

The inductance of the core without the bias magnet 150 is greater than the inductance of the core with the bias magnet 150 when current flowing through a coil is less than or equal to approximately 12 A. However, when current flowing through the coil exceeds 12 A, the core without the bias magnet 150 enters a saturation region and the inductance decreases significantly. In contrast, the core with the bias magnet 150 maintains an inductance value of 200 microhenries (μH) even when current flowing through a coil exceeds 12 A and reaches 20 A. Accordingly, it is seen that the core with the bias magnet 150 does not reach a saturation region even when current flowing through the coil increases to a significant degree, compared to the core without the bias magnet 150.

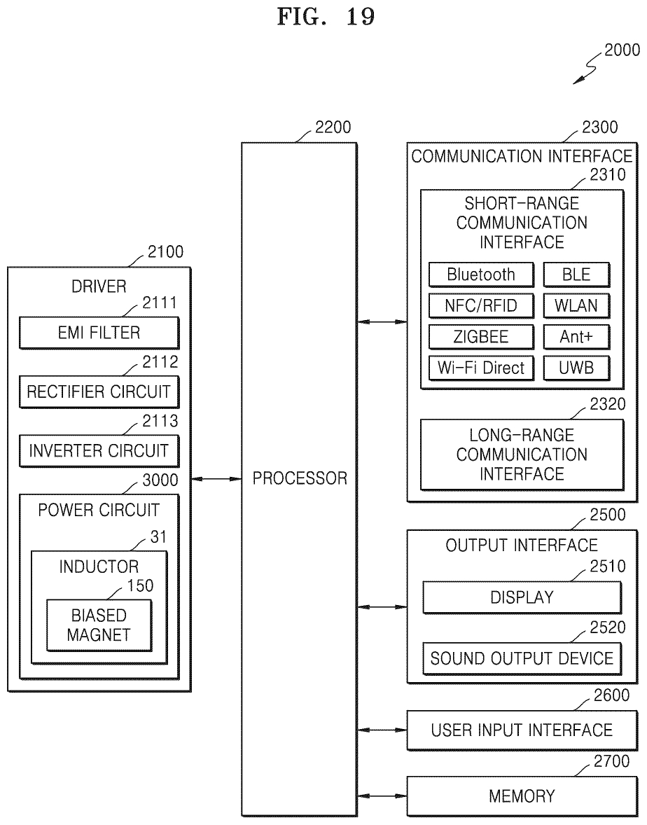

FIG. 19 is a block diagram of a home appliance according to an embodiment of the disclosure.

As shown in FIG. 19, a home appliance 2000 according to an embodiment of the disclosure may include a driver 2100, a processor 2200, a communication interface 2300, an output interface 2500, a user input interface 2600, and memory 2700. All the components of the home appliance 2000 are not necessarily essential, and another component may be added or some components may be omitted depending on a manufacturer's design concept.

Hereinafter, the components of the home appliance 2000 will be described.

The driver 2100 may receive power from an external source (ES), and supply the power to a load according to a driving control signal from the processor 2200. The driver 2100 may include, but is not limited thereto, an Electro Magnetic Interference (EMI) filter 2111, a rectifier circuit 2112, an inverter circuit 2113, and a power circuit 3000.

The EMI filter 2111 may block high-frequency noise included in alternating current (AC) power supplied from the ES and transmit an AC voltage and AC of a preset frequency (for example, 50 Hz or 60 Hz). A fuse and relay may be provided between the EMI filter 2111 and the ES to block overcurrent. The AC power from which the high-frequency noise has been blocked by the EMI filter 2111 may be supplied to the rectifier circuit 2112.

The rectifier circuit 2112 may be a circuit such as the rectifier 20 of FIG. 1A. The rectifier circuit 2112 may convert an AC voltage into a direct current (DC) voltage. For example, the rectifier circuit 2112 may convert an AC voltage of which a magnitude and polarity (a positive voltage or a negative voltage) change over time, into a DC voltage having a constant magnitude and polarity, and convert AC of which a magnitude and direction (positive current or negative current) change over time, into DC having a constant magnitude. The rectifier circuit 2112 may include a bridge diode. For example, the rectifier circuit 2112 may include four diodes. The bridge diode may convert an input AC voltage of which a polarity changes over time into a positive voltage having a constant polarity, and AC of which a direction changes over time into positive current having a constant direction. According to an embodiment of the disclosure, the rectifier circuit 2112 may include two diodes and two thyristors. One thyristor and one diode may configure one rectifier leg, and another thyristor and another diode may configure another rectifier leg. However, this may correspond to a case in which input power is single-phase. When input power is three-phase, a rectifier circuit 2112 including three legs may be configured with three thyristors and three diodes. The processor 2200 may control the thyristors such that a voltage charged to the link capacitor increases gradually rather than abruptly.

The inverter circuit 2113 may include a switching circuit that supplies current to a load (not shown) or cuts off supply of current to the load. The switching circuit may include at least two switches. The at least two switches may be connected in series between plus and minus lines output from the rectifier circuit 2112. The at least two switches may be turned on or off according to a driving control signal from the processor 2200.

The inverter circuit 2113 may control current that is supplied to the load. For example, a magnitude and direction of current flowing to the load may change depending on turning on/off of the at least two switches included in the inverter circuit 2113. In this case, AC (e.g., having second voltage level different from the voltage level of the input AC voltage) may be supplied to the load. Sinusoidal AC may be supplied to the load according to switching operations of the at least two switches.

Because the inverter circuit 2113 of FIG. 19 is required to supply AC to a load, a home appliance 2000 that supplies DC to a load may not require the inverter circuit 2113. In other words, according to an embodiment of the disclosure, the home appliance 2000 may utilize the power circuit 3000 (e.g., PFC circuit 30) without utilizing the inverter circuit 2113 or completely omitting the inverter circuit 2113. According to a non-limiting embodiment, the power circuit 3000 is implemented as a PFC circuit 30 that may include the inductor 31 in which current flows in one direction, and the inductor 31 may include the bias magnet 150 for preventing saturation of the inductor 31. The inductor 31 and the bias magnet 150 according to an embodiment of the disclosure may not only be used in the PFC circuit 30 but also be used in various power circuits and/or power conversion devices such as, for example, a SMPS circuit.

The processor 2200 may control overall operations of the home appliance 2000. The processor 2200 may execute programs stored in the memory 2700 to control the communication interface 2300, the output interface 2500, the user input interface 2600, and the memory 2700.

The processor 2200 may include various processing circuitries and/or a plurality of processors. For example, the term “processor” used in this specification including the claims may include various processing circuitries by including at least one processor. One or more processors in the at least one processor may be configured to individually and/or collectively perform various functions described herein in a distributed manner. As used herein, “processor”, “at least one processor” and “one or more processors” may be configured to perform various functions. However, these terms may cover, without limitation, situations where one processor performs some of the functions and another processor(s) perform other parts of the functions, and situations where a single processor can perform all of the functions. Additionally, at least one processor may include a combination of processors that perform various functions of the disclosed functions in a distributed manner. The at least one processor may execute program instructions to achieve or perform various functions.

For example, the processor 2200 may be a single processor or a plurality of processors. The home appliance 2000 may include only a main processor or may include a main processor and at least one sub processor.

According to an embodiment of the disclosure, the processor 2200 may mount an artificial intelligence (AI) processor thereon. The AI processor may be manufactured in the form of a dedicated hardware chip for AI, or may be manufactured as a part of an existing general-purpose processor (e.g., central processing unit (CPU) or application processor) or a graphics-only processor (e.g., GPU) and mounted on the home appliance 2000.

According to an embodiment of the disclosure, the processor 2200 may perform controller operations of, for example, a harmonic extractor, a harmonic controller, a current controller, and a voltage controller that may be included in a controller (not shown) of the home appliance 2000. Herein, the harmonic controller, the current controller, and the voltage controller may be proportional integral (PI) controllers, but the disclosure is not limited thereto.

The processor 2200 may include the communication interface 2300 to operate on an Internet of Things (IoT) network or a home network as necessary.

The communication interface 2300 may include a short-range wireless communication interface 2310 and a long-range wireless communication interface 2320. The short-range communication interface 2310 may include, but is not limited thereto, a Bluetooth communication interface, a Bluetooth Low Energy (BLE) communication interface, a Near Field Communication (NFC) interface, a Wireless Local Area Network (WLAN) (WiFi) communication interface, a Zigbee communication interface, an infrared Data Association (IrDA) communication interface, a Wi-Fi direct (WFD) communication interface, an Ultra Wideband (UWB) communication interface, an Ant+ communication interface, etc. The long-range communication interface 2320 may receive/transmit a wireless signal from/to at least one of a base station, an external terminal, or a server on a mobile communication network. Herein, the wireless signal may include a voice call signal, a video call signal or various formats of data according to transmission/reception of text/multimedia messages. The long-range communication interface 2320 may include, but is not limited to, a 3^{rd} generation (3G) module, a 4^{th} generation (4G) module, a 5^{th} generation (5G) module, a Long Term Evolution (LTE) module, a Narrowband Internet of Things (NB-IoT) module, a Long-Term Evolution for Machines (LTE-M), etc.

According to an embodiment of the disclosure, the home appliance 2000 may communicate with an external server or another electrical device and transmit/receive data to/from the external server or the other electrical device through the communication interface 2300.

The output interface 2500 may be used to output an audio signal or a video signal, and may include a display 2510 and a sound output device 2520.

According to an embodiment of the disclosure, the home appliance 2000 may display information related to the home appliance 2000 through the display 2510. For example, the home appliance 2000 may display power factor information of the home appliance 2000 or a harmonic component value (for example, percentage or ampere (A) of each harmonic component with respect to input current) on the display 2510.

When the display 2510 and a touch pad form a layer structure to be configured as a touch screen, the display 2510 may be used as an input device, as well as an output device. The display 2510 may include at least one of a liquid crystal display (LCD), a thin film transistor-liquid crystal display (TFT-LCD), a light-emitting diode (LED), an organic light-emitting diode (OLED), a flexible display, a three-dimensional (3D) display, or an electrophoretic display. Also, according to an implementation type of the home appliance 2000, the home appliance 2000 may include two or more displays 2510.

The sound output device 2520 may output audio data received from the communication interface 1500 or stored in the memory 2700. Also, the sound output device 2520 may output a sound signal related to a function that is performed in the home appliance 2000. The sound output device 2520 may include a speaker, a buzzer, etc.

According to an embodiment of the disclosure, the output interface 2500 may display a current power level, an operation mode (for example, a low-noise mode, a normal mode, a high-power mode, etc.), a power factor control state, a current power factor, etc.

The user input interface 2600 may be used to receive an input from a user. The user input interface 2600 may include, but is not limited thereto, at least one of a key pad, a dome switch, a touch pad (a capacitive type, a resistive type, an infrared beam type, a surface acoustic wave type, an integral strain gauge type, a piezo effect type, etc.), a jog wheel, or a jog switch.

The user input interface 2600 may include a voice recognition module. For example, the home appliance 2000 may receive a voice signal which is an analog signal, through a microphone, and convert a voice part into computer-readable text by using an Automatic Speech Recognition (ASR) model. The home appliance 2000 may obtain an intention of a user's utterance by interpreting the converted text through a Natural Language Understanding (NLU) model. Herein, the ASR model or NLU model may be an AI model. The AI model may be processed by an AI-dedicated processor designed as a hardware structure specialized for processing AI models. The AI model may be created through training. Herein, being created through training may be that a basic AI model is trained by a training algorithm using a large amount of learning data, thereby creating a pre-defined operation rule or AI model set to perform a desired characteristic (or purpose). The AI model may be configured with a plurality of neural network layers. Each of the plurality of neural network layers may have a plurality of weight values, and perform a neural network operation through an operation between an operation result of a previous layer and the plurality of weight values.

Linguistic comprehension is technology for recognizing and applying/processing human language/characters, and includes Natural Language Processing, Machine Translation, Dialogue System, Question Answering, Speech Recognition/Synthesis, etc.

The memory 2700 may store a program for processing and control by the processor 2200, and store input/output data (for example, power factor information of the home appliance 2000, information about harmonic components, etc.). The memory 2700 may store an AI model.

The memory 2700 may include at least one type of storage medium among a flash memory type, a hard disk type, a multimedia card micro type, a card type memory (for example, Secure Digital (SD) or extreme Digital (XD) memory), Random Access Memory (RAM), Static Random Access Memory (SRAM), Read Only Memory (ROM), Electrically Erasable Programmable Read-Only Memory (EEPROM), Programmable Read-Only Memory (PROM), a magnetic memory, a magnetic disk, or an optical disk. Also, the home appliance 2000 may operate a web storage or a cloud server that performs a storage function on the Internet.

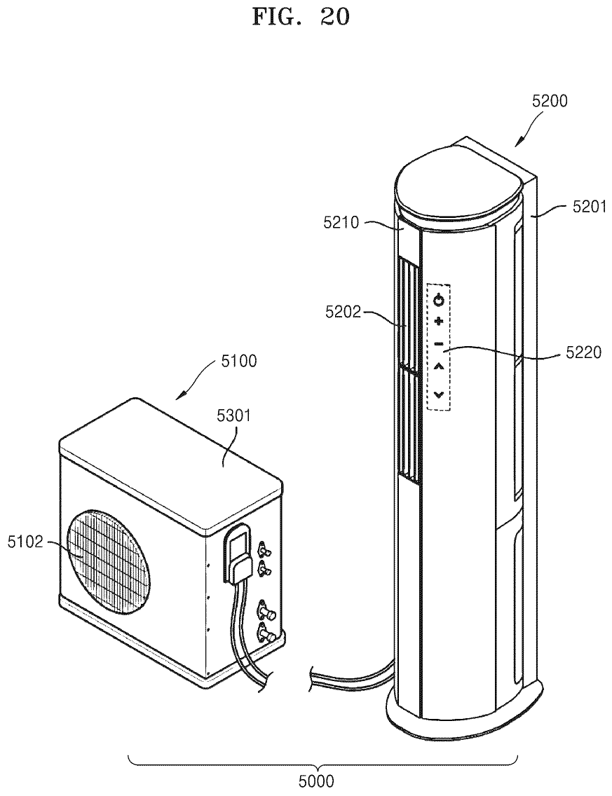

FIG. 20 shows an air conditioner using an inductor according to an embodiment of the disclosure.

An air conditioner 5000 according to an embodiment of the disclosure may absorb heat from an air-conditioned space (hereinafter, referred to as “indoor”) that is to be air-conditioned and discharge heat to outside (hereinafter, referred to as “outdoor”) of the air-conditioned space to cool the air-conditioned space. Also, the air conditioner 5000 may absorb heat from outdoor and discharge heat into indoor for heating indoor spaces.

The air conditioner 5000 may include one, two, or more outdoor units 5100 installed outdoor, and one, two, or more indoor units 5200 installed indoor. An outdoor unit 5100 may be electrically connected to an indoor unit 5200. For example, a user may input information (or a command) for controlling the indoor unit 5200 through a user interface panel 5220, and the outdoor unit 5100 may operate in response to a user input of the indoor unit 5200.

The outdoor unit 5100 may be fluidically connected to the indoor unit 5200 through a refrigerant pipe.

The outdoor unit 5100 may be installed outdoor. The outdoor unit 5100 may perform heat exchange between a refrigerant and outside air by using phase changes of the refrigerant. At this time, heat exchange may occur through an outdoor heat exchanger included in the outdoor unit 5100. For example, while a refrigerant is condensed in the outdoor unit 5100, the refrigerant may discharge heat to outside air. While the refrigerant evaporates in the outdoor unit 5100, the refrigerant may absorb heat from outside air.

The indoor unit 5200 may be installed indoor. The indoor unit 5200 may perform heat exchange between a refrigerant and indoor air by utilizing phase changes (for example, evaporation or condensation) of the refrigerant. At this time, heat exchange may occur through an indoor heat exchanger included in the indoor unit 5200. For example, while a refrigerant evaporates in the indoor unit 5200, the refrigerant may absorb heat from indoor air, and an indoor space may be cooled. While the refrigerant is condensed in the indoor unit 5200, the refrigerant may discharge heat to indoor air, and the indoor space may be heated. The air conditioner 5000 may include a compressor, the outdoor heat exchanger, an expander, and the indoor heat exchanger. The air conditioner 5000 may include a refrigerant pipe that connects the compressor, the outdoor heat exchanger, the expander, and the indoor heat exchanger to each other.

The indoor unit 5200 of the air conditioner 5000 may include the user interface panel 5220 that displays operation information of the air conditioner 5000 and receives a command from a user. A display unit of the user interface panel 5220 may receive information about an operation of the air conditioner 5000 from a processor that controls operations of the air conditioner 5000 and display information corresponding to the received information. The display may include an indicator that displays an operation mode of the air conditioner 5000, selected by a user, or power-on/off of the indoor unit 5200. The indicator may include, for example, a LCD panel, a LED panel, or a plurality of LEDs.

The outdoor unit 5100 may include an outdoor unit body 5101 forming an appearance of the outdoor unit 5100, and an outdoor unit fan 5102 provided on one side of the outdoor unit body 5101 to discharge heat-exchanged air.

The indoor unit 5200 may include an indoor unit body 5201 forming an appearance of the indoor unit 5200, an indoor unit outlet 5202 provided in a front side of the indoor unit body 5201 to discharge heat-exchanged air, and the user interface panel 5220 for receiving an operation command for the air conditioner 5000 from a user.

The air conditioner 5000 of FIG. 20 may include a power circuit 3000 such as a SMPS or a PFC circuit 30, for example, which includes an inductor equipped with the bias magnet 150 according to an embodiment of the disclosure.

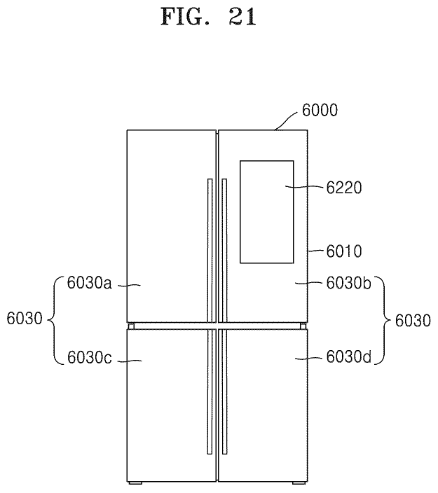

FIG. 21 shows a refrigerator using an inductor according to an embodiment of the disclosure.

Referring to FIG. 21, a refrigerator 6000 according to an embodiment of the disclosure may include an inductor equipped with the bias magnet 150. The inductor may be included in a power circuit 3000 such as, for example, a SMPS or a PFC circuit 30. The refrigerator 6000 may include a main body 6010. The main body 6010 may include an inner case, an outer case positioned inside the inner case, and an insulation provided between the inner case and the outer case.

The “inner case” may include a case, a plate, a panel, or a liner, which forms a storage room. The inner case may be formed as one body, or the inner case may be formed by assembling a plurality of plates together. The “outer case” may form an appearance of the main body 6010, and be coupled to an outer side of the inner case such that the insulation is positioned between the inner case and the outer case.

The “insulation” may insulate inside of the storage room from outside of the storage room to maintain inside temperature of the storage room at appropriate temperature without being influenced by an external environment of the storage room. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material, and a cladding material accommodating the core material and sealing the inside with vacuum or pressure close to vacuum. The vacuum insulation may further include an adsorbent for adsorbing a gas and water to stably maintain a vacuum state. However, the insulation is not limited to the above-mentioned foaming insulation or vacuum insulation, and may include various materials capable of being used for insulation.

The refrigerator 6000 according to an embodiment of the disclosure may include a cool air supply device for supplying cool air to the storage room.

The “cool air supply device” may include a machine, an apparatus, an electronic device, and/or a combination system thereof, capable of generating cool air and guiding the cool air to cool the storage room.

According to an embodiment of the disclosure, the cool air supply device may generate cool air through a cooling cycle including compression, condensation, expansion, and evaporation processes of refrigerants. To this end, the cool air supply device may include a compressor, a condenser, an expander, and an evaporator to drive the cooling cycle.

The refrigerator according to an embodiment of the disclosure may include a machine room where at least some components belonging to the cool air supply device are installed.

The “machine room” may be partitioned and insulated from the storage room to prevent heat generated from the components installed in the machine room from being transferred to the storage room. To dissipate heat from the components installed inside the machine room, the machine room may communicate with outside of the main body.

The refrigerator 6000 may be a kind of home appliance that keeps various foods fresh for a long time by supplying cool air generated by the compressor of the cool air supply device to the storage room. The refrigerator 6000 may have, in addition to such a long-time storage function, various functions, and representative ones of the various functions may be a communication function of enabling a configuration of a IoT network and a function of outputting sound through a speaker installed in the refrigerator 6000.

Referring to FIG. 21, the refrigerator 6000 according to an embodiment of the disclosure may include the main body 6010, and doors 6030a, 6030b, 6030c, and 6030d that open or close the storage room.

The refrigerator 6000 according to an embodiment of the disclosure may include doors 6030 configured to open or close an open side of the storage room.

In the refrigerator 6000 of FIG. 21, four doors 6030 are shown. However, the number of the doors 6030 is not limited thereto. An upper door 6030a and a lower door 1030b of a right side of the refrigerator 6000 may be configured as one door, and an upper door 6030c and a lower door 6030d of a left side of the refrigerator 6000 may be configured as one door. Also, the number of the doors 6030 of the refrigerator 6000 may be more or less than four. Also, positions of the doors 6030 may change variously. According to arrangements of the doors 6030 and the storage room, the refrigerator 6000 may be classified into a French door type refrigerator, a side-by-side type refrigerator, etc. Between the plurality of doors 6030a, 6030b, 6030c, and 6030d, there may be a handle area, which is a space where a user inserts his/her hand to open or close the doors 6030.

While the doors 6030 are closed, the doors 6030 may close the storage room. The doors 6030 may include an insulation to insulate the storage room when the doors 6030 are closed, like the main body 6010.

The refrigerator 6000 according to an embodiment of the disclosure may include a user interface panel 6220 on the doors 6030. The user interface panel 6220 may be located on any of the doors 6030a, 6030b, 6030c, and 6030d.

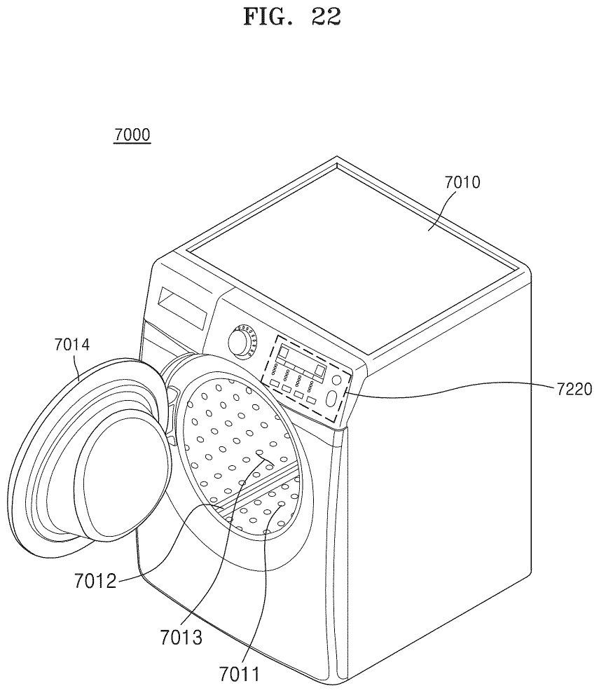

FIG. 22 shows a washing machine using an inductor according to an embodiment of the disclosure.

A washing machine 7000 of FIG. 22 may include an inductor equipped with the bias magnet 150. The inductor may be included in a power circuit 3000 such as, for example a SMPS or a PFC circuit 30, and the washing machine 7000 may include the power circuit, e.g., the SMPS or the PFC circuit 30.

The washing machine 7000 may include a main body 7010, a water tank (not shown) installed inside the main body 7010, and a drum 7011 installed inside the water tank. A lifter that raises laundry and then drops the laundry by gravity while the drum 7011 rotates may be mounted on an inner side of the drum 7011. The drum 7011 may perform washing, rinsing, and/or dehydrating while rotating inside a tub which will be described below. The drum 7011 may include a through hole that connects an inside space of the drum 7011 with an inside space of the tub. The drum 7011 may have a substantially cylindrical shape of which one side opens.

The main body 7010 of the washing machine 700 may generally have a hexahedral shape, but the disclosure is not limited thereto. In a front center of the main body 7010, an opening 7010 for allowing a user to put laundry into the drum 7011 or take laundry out of the drum 7011 may be formed, and a door 7014 for opening or closing the opening 7013 may be rotatably installed. At least one portion of the door 7014 may be transparent or translucent to show an inside surrounded by the drum 7011.

The washing machine 7000 may include the tub provided inside the water tank to store water, which is not shown in FIG. 22. The tub may be supported on an inner side of the water tank. The tub may have a substantially cylindrical shape of which one side opens. The tub may be elastically supported from the water tank by a damper. The damper may connect the tub to the water tank. The damper may attenuate vibrations generated during a rotation of the drum 7011 by absorbing vibration energy between the tub and the water tank upon transferring of the vibrations to the tub and/or the water tank.

On a front and upper portion of the main body 7010, a user interface panel 7220 may be mounted to display an operation state of the washing machine 700 for a user or enable a user to himself/herself control a washing operation. The user interface panel 7220 may include an input device as an input interface that receives an operation command from a user, and a display as an output interface that displays operation information of the washing machine 7000.

The input device may provide an electrical output signal corresponding to a user input to a controller (not shown) including a processor. The input device may include, for example, a power button, a start button, a course selection dial (or a course selection button), and a washing/rinsing/dehydrating setting button. An input button of the input device may include, for example, a tact switch, a push switch, a slide switch, a toggle switch, a micro switch, or a touch switch.

The display may receive a signal from the processor, and display information corresponding to the received signal. The display may include a screen that displays a washing course selected by a rotation of the course selection dial (or, pressing of the course selection button) and an operation time of the washing machine 7000, and an indicator that displays a washing setting/rinsing setting/dehydrating setting selected by the setting button. The display may include, for example, a LCD panel, a LED panel, etc.

The washing machine 7000 may include a driver (not shown) configured to rotate the drum 7011, which is not shown in FIG. 22.

The driver may include a driving motor, and a rotating shaft (not shown) for transferring a driving force generated by the driving motor to the drum 7011. The rotating shaft may penetrate the tub and connect to the drum 7011. The driver may rotate the drum 7011 forward or backward to perform a washing, rinsing, and/or dehydrating operation.

A water supply (not shown) may supply water to the tub. The water supply may include a water supply pipe and a water supply valve provided in the water supply pipe. The water supply pipe may be connected to an external water source. The water supply pipe may extend from the external water source to a detergent supply device (not shown) and/or the tub. Water may be supplied to the tub via the detergent supply device. Water may be supplied to the tub not via the detergent supply device.

The water supply valve (not shown) may open or close the water supply pipe in response to an electrical signal from the processor. The water supply valve may allow or block supply of water from the external water supply source to the tub. The water supply valve may include, for example, a solenoid valve that is opened or closed in response to an electrical signal.

The washing machine 7000 may include the detergent supply device configured to supply a detergent to the tub. The detergent supply device may supply a detergent to the inside of the tub during a water supply process. Water supplied through the water supply pipe may be mixed with the detergent via the detergent supply device. The water mixed with the detergent may be supplied to the inside of the tub. The detergent may include a conditioner for dryer, a deodorant, a sterilizer, or an air freshener, as well as a washing detergent.

The washing machine 7000 may include a drain device (not shown). The drain device may be configured to discharge water accommodated in the tub to outside. The drain device may include a drain pipe extending from a lower portion of the tub to the outside of the water tank, and a pump provided on the drain pump. The pump may pump water in the drain pipe to the outside of the water tank.

In the lower portion of the tub, a drain (not shown) for draining water stored in the tub to the outside of the tub may be formed. The drain may be connected to the drain pipe. In the drain pipe, a drain valve may be provided to open or close the drain pipe.

The controller including the processor may control various components (for example, the driving motor and the water supply valve) of the washing machine 7000. The controller may control various components of the washing machine 7000 to perform at least one operation including a water supply operation, a washing operation, a rinsing operation, and/or a dehydrating operation according to a user input inputted to the control panel. For example, the controller may control the driving motor to adjust a rotation speed of the tub, or control the water supply valve of the water supply device to supply water to the tub.

The controller may include hardware, such as CPU and memory, and software such as a control program. For example, the controller may include at least one memory that stores algorithms for controlling the operations of components in the washing machine 7000 or data with program formats, and at least one processor that performs the above-described operations by using the data stored in the at least one memory. The memory and the processor may be implemented as separate chips. The processor may include one, two, or more processor chips or may include one, two, or more processing cores. The memory may include one, two, or more memory chips or may include one, two, or more memory blocks. Also, the memory and the processor may be implemented as a single chip.

The washing machine 7000 of a front loading type shown in FIG. 22 may wash laundry by rotating the drum 7011 to repeatedly raise and drop the laundry.

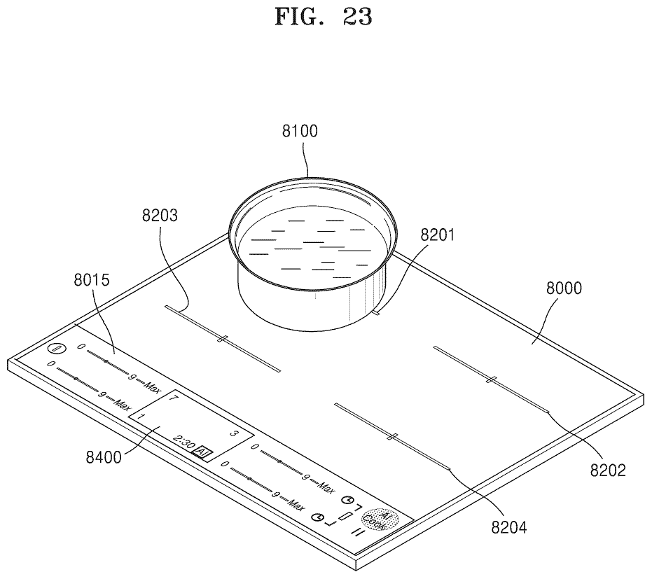

FIG. 23 shows an induction heating device using an inductor according to an embodiment of the disclosure.

Referring to FIG. 23, an induction heating device 8000 which is a home appliance according to an embodiment of the disclosure may include a power circuit 3000 such as a SMPS, for example, and the SMPS may include an inductor equipped with the bias magnet 150.

The induction heating device 8000 may include a plurality of cooking areas 8201, 8202, 8203, and 8204.

A cooking vessel 8100 may be a device for heating contents therein. The cooking vessel 8100 may receive power wirelessly from the induction heating device 8000 by using electromagnetic induction. Accordingly, the cooking vessel 8100 according to an embodiment of the disclosure may not include a power line that is connected to a power outlet.

According to an embodiment of the disclosure, the cooking vessel 8100 that receives power wirelessly from the induction heating device 8000 may have various types. The cooking vessel 8100 may include a general induction heating (IH) vessel (hereinafter, IH vessel) containing a magnetic material.

The induction heating device 8000 according to an embodiment of the disclosure may be a device that transmits power wirelessly to the cooking vessel 8100 placed on a top plate of the induction heating device 8000 using electromagnetic induction. The induction heating device 8000 may include a working coil that generates a magnetic field for inductively heating the cooking vessel 8100. The working coil may be a coil for forming a magnetic field through an electrical flow, and may be referred to as a heating coil throughout the disclosure.

Generating a magnetic field by a heating coil may include transmitting power by utilizing a magnetic field induced in an IH metal (for example, iron) by magnetic induction. For example, the induction heating device 8000 may generate eddy current in the cooking vessel 8100 by flowing current through the heating coil to form a magnetic field.

According to an embodiment of the disclosure, the induction heating device 8000 may include a plurality of heating coils. For example, in the case in which the top plate of the induction heating device 8000 includes a plurality of cooking areas, the induction heating device 8000 may include a plurality of heating coils respectively corresponding to the plurality of cooking areas.

The top plate of the induction heating device 8000 according to an embodiment of the disclosure may be made of reinforced glass such as ceramic glass not to be easily broken.

According to an embodiment of the disclosure, the induction heating device 8000 may include a communication interface for communicating with an external device. For example, the induction heating device 8000 may communicate with the cooking vessel 8100 or a server through the communication interface. The communication interface may include a short-range communication interface (for example, an NFC communication interface, a Bluetooth communication interface, a BLE communication interface, etc.), a mobile communication interface, etc.

According to an embodiment of the disclosure, the induction heating device 8000 may display various information and receive a user command through a user interface 8015. The user interface panel 8015 may include an input device as an input interface that receives an operation command from a user, and a display as an output interface that displays operation information of the induction heating device 8000. The input device as an input interface may include a touch key that operates by touch.

The input device may provide an electrical output signal corresponding to a user input to a control unit (not shown) including a processor. The input device may include, for example, as input buttons, a power button, a start button, and a heating stage setting button.

The display may receive a signal from the processor and display information corresponding to the received signal. The display may include a display 8400 that indicates a heating stage. The display may include, for example, a LCD panel, a LED panel, etc.

According to an embodiment of the disclosure, a home appliance including an inductor equipped with a bias magnet is disclosed. According to an embodiment of the disclosure, a home appliance may include a rectifier circuit configured to rectify an AC voltage of an input power source, a power circuit configured to correct a power factor of a voltage rectified by the rectifier circuit, and a link capacitor connected to the PFC circuit and configured to smooth a DC voltage. Although a PFC circuit is described, other non-limiting embodiments of the home appliance may implement additional power circuits that perform power conditioning on the output provided by the rectifier circuit (e.g., the rectified DC voltage) and implements an inductor that utilizes a bias magnet. The power circuit includes, for example, a PFC circuit configured to correct a power factor of a voltage rectified by the rectifier circuit, and the PFC circuit may include an inductor. According to an embodiment of the disclosure, the power circuit of the home appliance may include a SMPS, instead of the PFC circuit. According to an embodiment of the disclosure, the power circuit of the home appliance may include a power converter including the inductor, instead of the PFC circuit.

According to an embodiment of the disclosure, the inductor included in the power circuit, e.g., the PFC circuit, the SMPS, and/or the power converter, may include a core including an air gap in a first leg. According to an embodiment of the disclosure, the inductor may include a coil wound around at least a part of the core such that flux flows through the first leg. According to an embodiment of the disclosure, the inductor may include an upper magnet positioned above the air gap in the first leg. According to an embodiment of the disclosure, the inductor may include a lower magnet positioned below the air gap in the first leg. In the inductor according to an embodiment of the disclosure, a direction of flux by the coil may be opposite to a direction of flux by the upper magnet and the lower magnet. According to an embodiment of the disclosure, the inductor may include only any one of the upper magnet or the lower magnet when the upper magnet or the lower magnet includes an electromagnetic coil formed by winding a coil.

In the inductor according to an embodiment of the disclosure, a polarity arrangement of the upper magnet may be opposite to a polarity arrangement of the lower magnet.

In the inductor according to an embodiment of the disclosure, the first leg may be a center leg of the core.

In the inductor according to an embodiment of the disclosure, the coil may be wound around the first leg.

In the inductor according to an embodiment of the disclosure, the first leg may be both side legs of the core.

In the inductor according to an embodiment of the disclosure, a first upper magnet positioned on a first side leg of the core may have a polarity opposite to a polarity of a second upper magnet positioned on a second side leg of the core.

In the inductor according to an embodiment of the disclosure, no air gap may exist in the center leg of the core.

In the inductor according to an embodiment of the disclosure, the coil may be wound around the center leg.

The inductor according to an embodiment of the disclosure may be a rectangular core, and the coil may be wound around a second leg that is opposite to the first leg.

In the inductor according to an embodiment of the disclosure, the upper magnet may be positioned on an outer side of the first leg from a center of the core while the lower magnet may be positioned on an inner side of the first leg, or the upper magnet may be positioned on the inner side of the first leg from the center of the core while the lower magnet may be positioned on the outer side of the first leg.

In the inductor according to an embodiment of the disclosure, the upper magnet and the lower magnet may surround at least a part of a circumference of the first leg.

In the inductor according to an embodiment of the disclosure, the upper magnet and the lower magnet may surround the at least a part of the circumference of the first leg in a circular shape or a rectangular shape.

In the inductor according to an embodiment of the disclosure, when the upper magnet and the lower magnet surround the at least a part of the circumference of the first leg in the rectangular shape, the upper magnet and the lower magnet may be attached on at least a part of four sides of the rectangular shape.

In the inductor according to an embodiment of the disclosure, a N pole and a S pole of each of the upper magnet and the lower magnet may be arranged in a horizontal direction of the first leg.

In the inductor according to an embodiment of the disclosure, a N pole and a S pole of each of the upper magnet and the lower magnet may be arranged in a vertical direction of the first leg.

In the inductor according to an embodiment of the disclosure, the upper magnet and the lower magnet may be permanent magnets.

In the inductor according to an embodiment of the disclosure, at least one of the upper magnet or the lower magnet may be an electromagnet formed by winding a coil for an electromagnet, and only any one of the upper magnet or the lower magnet may be used as a bias magnet.

In the home appliance according to an embodiment of the disclosure, the home appliance may be at least one of an air conditioner, a refrigerator, or a washing machine, and a load connected to the PFC circuit or the power converter may be a motor. According to an embodiment of the disclosure, the load may be an energy storage device or a battery, instead of the motor.

The inductor according to an embodiment of the disclosure may include a bobbin coupled to the core, and the bobbin may include a space for supporting the upper magnet and the lower magnet.

A home appliance according to an embodiment of the disclosure may include a core including an air gap in a first leg. According to an embodiment of the disclosure, the home appliance may include a coil wound around at least a part of the core such that flux flows through the first leg. According to an embodiment of the disclosure, the home appliance may include a bias magnet having a smaller width than a width of a cross-section of the air gap and a smaller height than a gap height of the air gap in the first leg, the bias magnet being positioned on at least one of cross-sections of the air gap. According to an embodiment of the disclosure, the home appliance may include an inductor in which the bias magnet is positioned at a center of the cross-section of the air gap and a direction of flux by the coil is opposite to a direction of flux by the bias magnet.

A home appliance according to an embodiment of the disclosure may include an inductor. The inductor according to an embodiment of the disclosure may include a core including an air gap in a first leg, and a coil wound around at least a part of the core such that flux flows through the first leg. The inductor according to an embodiment of the disclosure may include an upper magnet positioned above the air gap in the first leg, and a lower magnet positioned below the air gap in the first leg. In an embodiment of the disclosure, according to the upper magnet or the lower magnet being an electromagnet by a coil, only any one of the upper magnet or the lower magnet may be used. In the inductor according to an embodiment of the disclosure, a direction of flux by the coil may be opposite to a direction of flux by the upper magnet and the lower magnet.

The method according to an embodiment of the disclosure may be implemented in a program command form that can be executed by various computer means, and may be recorded on computer-readable media. The computer-readable media may also include, alone or in combination with program commands, data files, data structures, and the like. Program commands recorded in the media may be the kind specifically designed and constructed for the disclosure or well-known and available to those of ordinary skill in the computer software field. Examples of the computer-readable media include magnetic media, such as hard disks, floppy disks, and magnetic tapes, optical media, such as compact disc read only memory (CD-ROM) and digital versatile disc (DVD), magneto-optical media such as floptical disks, and hardware devices, such as ROM, RAM, flash memory, and the like, specifically configured to store and execute program commands. Examples of the program commands may include high-level language codes that can be executed on a computer through an interpreter or the like, as well as machine language codes produced by a compiler.

An embodiment of the disclosure may be implemented in the form of a computer-readable recording medium including an instruction that is executable by a computer, such as a program module that is executed by a computer. The computer-readable recording medium may be an arbitrary available medium which can be accessed by a computer, and may include a volatile or non-volatile medium and a separable or non-separable medium. Further, the computer-readable recording medium may include a computer storage medium and a communication medium. The computer storage medium may include volatile and non-volatile media and separable and non-separable media implemented by an arbitrary method or technology for storing information such as a computer readable instruction, a data structure, a program module, or other data. The communication medium may generally include a computer readable instruction, a data structure, a program module, other data of a modulated data signal such as a carrier wave, or another transmission mechanism, and include an arbitrary information transmission medium. Also, an embodiment of the disclosure may be implemented as a computer program including instructions executable by a computer, such as a computer program that is executed by a computer, or as a computer program product.

The computer-readable storage media may be provided in a form of non-transitory storage media. Herein, the term ‘non-transitory storage medium’ means that it is a tangible device, and does not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment of the disclosure, the method according to various embodiments of the disclosure may be included and provided in a computer program product. The computer program product may be traded as a product between a seller and a buyer. The computer program product may be distributed in the form of a machine-readable storage medium (e.g., CD-ROM), or be distributed (e.g., downloadable or uploadable) online via an application store or between two user devices (e.g., smart phones) directly. When distributed online, at least a part of the computer program product (e.g., a downloadable app) may be temporarily generated or at least temporarily stored in a machine-readable storage medium, such as a memory of the manufacturer's server, a server of the application store, or a relay server.

1. A home appliance comprising:
a rectifier circuit configured to rectify an alternating current (AC) voltage of an input power source;
a power circuit in signal communication with the rectifier circuit including an inductor that utilizes a magnet, the power circuit configured to perform power conditioning on the rectified DC voltage; and
a link capacitor connected to the power circuit and configured to smooth the rectified DC voltage,
wherein the power circuit comprises an inductor, and the inductor comprises
a core including an air gap in a first leg,
a coil wound around at least a part of the core such that flux flows through the first leg,
an upper magnet positioned above the air gap in the first leg, and
a lower magnet positioned below the air gap in the first leg, wherein a direction of flux by the coil is opposite to a direction of flux by the upper magnet and the lower magnet.

2. The home appliance of claim 1, wherein:
a polarity arrangement of the upper magnet is opposite to a polarity arrangement of the lower magnet.

3. The home appliance of claim 1, wherein:
the power circuit comprises at least one selected from a group of a power factor correction (PFC) circuit configured to correct a power factor of a voltage rectified by the rectifier circuit, a switch mode power supply (SMPS), and a power converter.

4. The home appliance of claim 1, wherein:
the first leg is a center leg of the core and
the coil is wound around the first leg.

5. The home appliance of claim 1, wherein:
the first leg corresponds to both side legs of the core.

6. The home appliance of claim 5, wherein:
upper magnets positioned in both side legs of the core have opposite polarities to each other.

7. The home appliance of claim 5, wherein the core includes a center leg, and the center leg excludes an air gap.

8. The home appliance of claim 7, wherein:
the coil is wound around the center leg.

9. The home appliance of claim 1, wherein:
the coil is wound around a second leg that is opposite to the first leg.

10. The home appliance of claim 9, wherein:
the upper magnet is positioned on an outer side of the first leg from a center of the core and the lower magnet is positioned on an inner side of the first leg from the center of the core, or
the upper magnet is positioned on the inner side of the first leg from the center of the core and the lower magnet is positioned on the outer side of the first leg from the center of the core.

11. The home appliance of claim 1, wherein:
the upper magnet and the lower magnet surround at least a part of a circumference of the first leg.

12. The home appliance of claim 11, wherein:
the upper magnet and the lower magnet surround the at least a part of the circumference of the first leg in a circular shape or a rectangular shape.

13. The home appliance of claim 12, wherein:
when the upper magnet and the lower magnet surround the at least a part of the circumference of the first leg in the rectangular shape, the upper magnet and the lower magnet are attached on at least a part of four sides of the rectangular shape.

14. The home appliance of claim 1, wherein:
a north (N) pole and a south(S) pole of each of the upper magnet and the lower magnet are arranged in a horizontal direction of the first leg.

15. The home appliance of claim 1, wherein:
a north (N) pole and a south(S) pole of each of the upper magnet and the lower magnet are arranged in a vertical direction of the first leg.

16. The home appliance of claim 1, wherein:
the upper magnet and the lower magnet are permanent magnets.

17. The home appliance of claim 1, wherein:
at least one of the upper magnet or the lower magnet is an electromagnet including a winding formed around one or both of the upper magnet and the lower magnet.

18. The home appliance of claim 1, being at least one of an air conditioner, a refrigerator, or a washing machine, wherein a load connected to the PFC circuit is a motor.

19. The home appliance of claim 1, wherein:
the inductor comprises a bobbin coupled to the core, and
the bobbin comprises a space for supporting the upper magnet and the lower magnet.

20. A home appliance comprising an inductor, wherein the inductor comprises:
a core comprising an air gap in a first leg;
a coil wound around at least a part of the core such that flux flows through the first leg;
an upper magnet positioned above the air gap in the first leg; and
a lower magnet positioned below the air gap in the first leg,
wherein a direction of flux by the coil is opposite to a direction of flux by the upper magnet and the lower magnet.
